(19) United States
(12) Patent Application Publication
(10) Pub. No.: US 2021/0279469 A1
(43) Pub. Date: Sep. 9, 2021

(54) IMAGE SIGNAL PROVENANCE ATTESTATION

(71) Applicant: QUALCOMM Incorporated, San Diego, CA (US)

(72) Inventor: Wesley James Holland, Encinitas, CA (US)

(21) Appl. No.: 16/810,720

(22) Filed: Mar. 5, 2020

(51) Int. Cl. G06K 9/00; H04N 5/232; G06K 9/62; H04N 13/271

(52) U.S. Cl. CPC G06K 9/00677; H04N 5/232122; G06K 9/6232; G06K 2209/27; G06K 9/6259; H04N 5/23222; H04N 13/271; G06K 9/00208

(57) ABSTRACT

A computing device is configured to determine the provenance of an image. The computing device may receive an image. The computing device may generate an image capture profile associated with the image based at least in part on data generated during an image capture process. The computing device may determine whether the image is an authentic image based at least in part on the image capture profile. The computing device may, in response to determining that the image is an authentic image, generate a digital signature associated with the image.

### TECHNICAL FIELD

This disclosure generally relates to image and video processing, and more particularly, to techniques for controlling the operation of a camera processor and/or camera module.

### BACKGROUND

Image capture devices (e.g., digital cameras) are commonly incorporated into a wide variety of devices. An image capture device refers to any device that can capture one or more digital images, including devices that can capture still images and devices that can capture sequences of images to record video. By way of example, image capture devices may comprise stand-alone digital cameras or digital video camcorders, camera-equipped wireless communication device handsets such as mobile telephones, cellular or satellite radio telephones, tablet computers, laptop computers camera-equipped personal digital assistants (PDAs), computer devices that include cameras such as so-called “web-cams,” or any devices with digital imaging or video capabilities.

### SUMMARY

In general, this disclosure describes techniques for determining the provenance of images (e.g., photographs and videos) captured by a digital camera functionality of a device. The provenance of an image may include the location where the image was captured, the person who captured the image, the day and time when the image was captured, a history of edits made to the image, and whether the image is real (e.g., not manipulated and/or edited after capture). An authentic image, for the purposes of this disclosure is an image captured by a camera sensor of the device that is faithful record of a real physical scene captured by a camera sensor of the device. This is in contrast to, for example, images that are not captured by a camera sensor of the device (e.g., images injected into the camera processor of the device, images in which the camera sensor of the device captures a printed picture (e.g., a sheet of paper) or a display (e.g., a screenshot) that depicts a physical scene that is not real, or other images that are a result of any other techniques employed by malicious users attempting to fool the device into determining that the images are faithful records of real physical scene.

Recently discovered deep neural network techniques, such as generative adversarial networks (GANs), enable automatic editing of images and videos to produce convincing and photorealistic fake images and videos. Such fake images and videos are sometimes referred to as deep fakes. Deep fakes may have a variety of malicious uses, such as political disinformation, likeness and/or trademark violations, blackmail, and the like. A variety of forensic techniques exist to detect deep fakes and other photo and/or video manipulation after such photos and/or videos have been created. However, such forensic techniques may be fallible, may take time, and may require specific personal expertise in order to correctly apply such techniques.

Accordingly, the techniques described in the present disclosure may overcome some of these problems. For example, the techniques disclosed herein may be able to access a large amount of data regarding the image capture process of an image, thereby minimizing the risk of authenticating a fake image. Further, the techniques disclosed herein may be applied immediately when the device receives an image, thereby minimizing any potential damage that may be caused by spreading a fake image. In addition, the techniques disclosed herein are relatively simple and automatic, thereby allowing widespread deployment of the techniques disclosed herein by non-expert users.

As such, aspects of the present disclosure are directed to determining, by a device, such as a mobile computing device, whether an image captured by the digital camera functionality of the device (e.g., the camera functionality of a mobile phone) is an authentic image, such as being a faithful record of a real physical scene captured by a camera sensor of the device, as described above. If the device determines that the image is an authentic image, the device may digitally sign the image to indicate that the image is an authentic image, and may store the image and its associated digital signature in memory. Conversely, if the device determines that the image is not an authentic image, the device may refrain from digitally signing the image and may refrain from storing the image in memory.

In one example of the disclosure, a method includes receiving an image. The method further includes generating an image capture profile associated with the image based at least in part on data generated during an image capture process. The method further includes determining whether the image is an authentic image based at least in part on the image capture profile. The method further includes in response to determining that the image is an authentic image, generating a digital signature associated with the image.

In another example of the disclosure, an apparatus includes a memory. The apparatus further includes processing circuitry in communication with the memory and configured to: receive an image; generate an image capture profile associated with the image based at least in part on data generated during an image capture process; determine whether the image is an authentic image based at least in part on the image capture profile; and in response to determining that the image is an authentic image, generate a digital signature associated with the image.

In another example of the disclosure, an apparatus includes means for receiving an image. The apparatus further includes means for generating an image capture profile associated with the image based at least in part on data generated during an image capture process. The apparatus further includes means for determining whether the image is an authentic image based at least in part on the image capture profile. The apparatus further includes means for generating a digital signature associated with the image in response to determining that the image is an authentic image.

In another example, this disclosure describes a computer-readable storage medium storing instructions that, when executed, cause one or more processors to: receive an image; generate an image capture profile associated with the image based at least in part on data generated during an image capture process; determine whether the image is an authentic image based at least in part on the image capture profile; and in response to determining that the image is an authentic image, generate a digital signature associated with the image.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a block diagram of a device configured to perform one or more of the example techniques described in this disclosure.

FIGS. 2A-2C illustrate techniques for determining the provenance of an image captured by a digital camera.

FIGS. 3A and 3B illustrate example methods for determining the provenance of an image.

FIG. 4 illustrates an example technique for generating an example image capture profile using camera sensor metrics.

FIG. 5 illustrates an example technique for generating an example image capture profile using depth information.

FIG. 6 illustrates an example technique for generating an example image capture profile using contrast statistics and corresponding auto focus commands.

FIG. 7 illustrates an example technique for generating an example image capture profile using brightness measurements and corresponding auto exposure commands.

FIG. 8 illustrates an example technique for generating an example image capture profile using images captured by multiple camera sensors.

FIG. 9 illustrates additional techniques for generating an example image capture profile.

FIGS. 10A-10E illustrate additional techniques for determining the provenance of an image captured by a digital camera.

FIG. 11 is flowchart illustrating an example method according to the disclosure.

### DETAILED DESCRIPTION

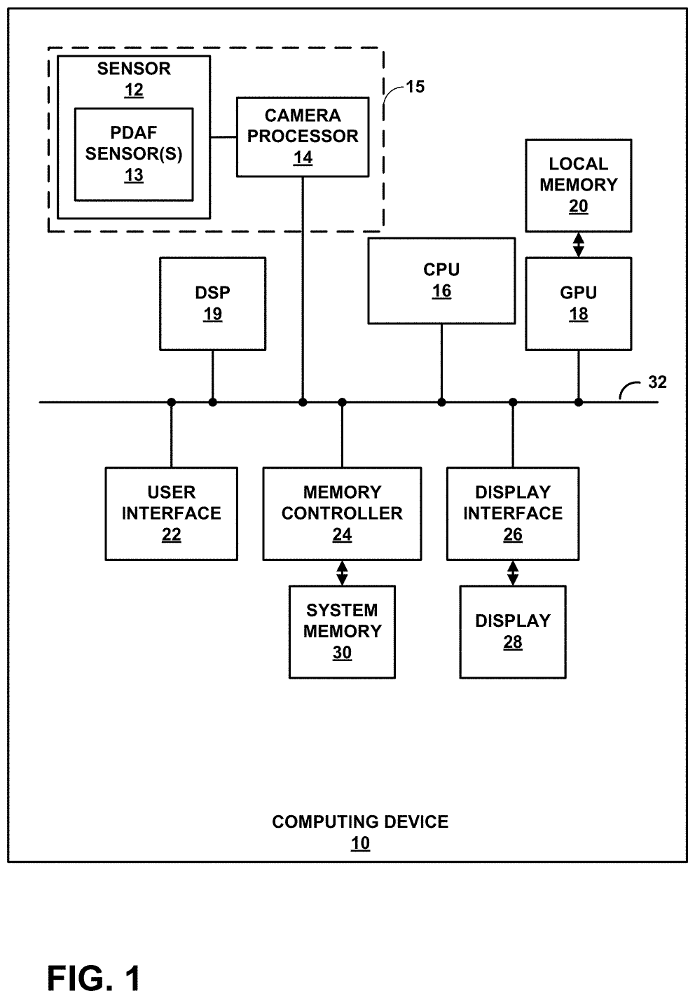

FIG. 1 is a block diagram of a device configured to perform one or more of the example techniques for provenance attestation of images and/or video described in this disclosure. Examples of computing device 10 include a computer (e.g., personal computer, a desktop computer, or a laptop computer), a mobile device such as a tablet computer, a wireless communication device (e.g., a mobile telephone, a cellular telephone, a satellite telephone, and/or a mobile telephone handset), an Internet telephone, a digital camera, a digital video recorder, a handheld device such as a portable video game device or a personal digital assistant (PDA) or any device that may include a camera.

As illustrated in the example of FIG. 1, computing device 10 includes a sensor 12, that includes an image sensor, a camera processor 14, a central processing unit (CPU) 16, a graphical processing unit (GPU) 18, local memory 20 of GPU 18, a digital signal processor (DSP) 19, user interface 22, memory controller 24 that provides access to system memory 30, and display interface 26 that outputs signals that cause graphical data to be displayed on display 28. Sensor 12 may be configured to include one or more image sensors (e.g., dual camera devices), such as an image sensor for a telephoto lens as well as an image sensor for a wide angle lens. While the example provenance attestation techniques are described with respect to a single sensor 12, the example techniques are not so limited, and may be applicable to the various camera types used for capturing images/videos, including devices that include multiple camera sensors (e.g., dual camera devices). In some examples, sensor 12 may operate as the sensor for multiple different lens, such as the sensor for both a telephoto lens as well as a wide angle lens and an ultra-wide angle lens. Sensor 12 and camera processor 14 may collectively be referred to as “digital camera 15.”

Although the various components are illustrated as separate components, in some examples the components may be combined to form a system on chip (SoC). As an example, camera processor 14, CPU 16, GPU 18, DSP 19, and display interface 26 may be formed on a common integrated circuit (IC) chip. In some examples, one or more of camera processor 14, CPU 16, GPU 18, DSP 19, and display interface 26 may be in separate IC chips. Various other permutations and combinations are possible, and the techniques should not be considered limited to the example illustrated in FIG. 1.

The various components illustrated in FIG. 1 (whether formed on one device or different devices), may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry. Examples of local memory 20 include one or more volatile or non-volatile memories or storage devices, such as random-access memory (RAM), static RAM (SRAM), dynamic RAM (DRAM), erasable programmable ROM (EPROM), electrically erasable programmable ROM (EEPROM), flash memory, a magnetic data media or an optical storage media.

The various structures illustrated in FIG. 1 may be configured to communicate with each other using bus 32. Bus 32 may be any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different components shown in FIG. 1 is merely exemplary, and other configurations of computing devices and/or other image processing systems with the same or different components may be used to implement the techniques of this disclosure.

GPU 18 may be configured to perform graphics operations to render one or more graphics primitives to display 28. Thus, when software applications executing on CPU 16 requires graphics processing, CPU 16 may provide graphics rendering commands along with graphics data to GPU 18 for rendering to display 28. The graphics data may include, e.g., drawing commands, state information, primitive information, texture information, etc. GPU 18 may, in some instances, be built with a highly-parallel structure that provides more efficient processing of complex graphic-related operations than CPU 16. For example, GPU 18 may include a plurality of processing elements, such as shader units, that are configured to operate on multiple vertices or pixels in a parallel manner. The highly parallel nature of GPU 18 may, in some instances, allow GPU 18 to draw graphics images (e.g., GUIs and two-dimensional (2D) and/or three-dimensional (3D) graphics scenes) onto display 28 more quickly than drawing the scenes directly to display 28 using CPU 16.

In other examples, in addition to graphics rendering, GPU 18 may be configured to perform various image processing techniques. The shader units of GPU 18 may be configured, with instructions received from CPU 16, to perform a wide variety image processing techniques, including rotation, skew correction, cropping, image sharpening, scaling, and the like.

GPU 18 may include a local memory 20 for more quickly accessing image data for processing. In some examples, local memory 20 may be part of GPU 18. For example, local memory 20 may be on-chip memory or memory that is physically integrated into the integrated circuit chip of GPU 18. If local memory 20 is on-chip, GPU 18 may be able to read values from or write values to local memory 20 more quickly than reading values from or writing values to system memory 30 via bus 32.

DSP 19 may be configured as a microprocessor that is optimized for digital signal processing. DSP 19 may be configured for measuring, filtering, and/or compressing digital signals (e.g., pixel values of image data). In some examples, the microprocessor of DSP 19 may be configured to perform a large number of mathematical functions repeatedly on a series of data samples. In the context of this disclosure, DSP 19 may be configured to perform image processing applications on pixel values of image data captured by sensor 12.

Camera processor 14 is configured to receive image data (e.g., frames of pixel data) from sensor 12, and process the image data to generate output image content. CPU 16, GPU 18, DSP 19, camera processor 14, or some other circuitry may be configured to process the image data captured by sensor 12 into images for display on display 28. In the context of this disclosure, the image data may be frames of data for a still image, or frames of video data. The image data may be received by camera processor 14 in any format, including different color formats, including RGB, YCbCr, YUV, and the like.

In some examples, camera processor 14 may be configured as an image signal processor. For instance, camera processor 14 may include a camera interface (e.g., called an image front end (IFE)) that interfaces between sensor 12 and camera processor 14. Camera processor 14 may include additional circuitry to process the image content. For example, camera processor 14 may include one or more image processing engines (IPEs) configured to perform various image processing techniques, including demosaicing, color correction, effects, denoising, filtering, compression, and the like.

In addition, camera processor 14 may be configured to analyze pixel data, including phase difference pixel data, to make image capture configuration changes to sensor 12. For example, camera processor 14 may be configured to analyze pixel data from sensor 12 to set and/or alter exposure control settings. In one example, camera processor 14 may perform an automatic exposure control (AEC) operation. An AEC process may include configuring, calculating, and/or storing an exposure setting of sensor 12. An exposure setting may include the shutter speed and aperture setting to use to capture an image.

In other examples, camera processor may be configured to analyze pixel data, including phase difference pixel data, from sensor 12 to set focus settings. An automatic focus (AF) process may include configuring, calculating and/or storing an auto focus setting for sensor 12. An AF process may include sending a lens position to sensor 12.

Camera processor 14 may be configured to output the resulting images (e.g., pixel values for each of the image pixels) to system memory 30 via memory controller 24. Each of the images may be further processed for generating a final image for display. For example, GPU 18 or some other processing unit, including camera processor 14 itself, may perform color correction, white balance, blending, compositing, rotation, or other operations to generate the final image content for display.

Camera sensor 12 may include processing circuitry, an image sensor including an array of pixel sensors (e.g., pixels) for capturing light, a memory, an adjustable lens, and an actuator to adjust the lens. Camera sensor 12 may include any type of image sensor, including one or more phase detection auto focus (PDAF) sensors 13. PDAF sensors 13, also referred to as PDAF pixels or focus pixels, may refer to specialized phase detection pixels which may be partially masked. These phase detection pixels may be formed as pairs referred to as “left” and “right” phase detection pixels. Computing device 10 may determine the phase difference between pairs of phase detection pixels in PDAF sensors 13 in order to, for example, perform an autofocus process for sensor 12.

In some examples, sensor 12 may include multiple cameras, such as in a dual camera system. In a dual camera system, camera sensor 12 may include two image sensors, each with their own individually controllable lenses and actuators. For example, camera sensor 12 may include an image sensor for a telephoto lens and an image sensor for a wide angle lens.

CPU 16 may comprise a general-purpose or a special-purpose processor that controls operation of computing device 10. A user may provide input to computing device 10 to cause CPU 16 to execute one or more software applications. The software applications that execute on CPU 16 may include, for example, an operating system, a word processor application, a web browser application, an email application, a graphics editing application, a spread sheet application, a media player application, a video game application, a graphical user interface application or another program. The user may provide input to computing device 10 via one or more input devices (not shown) such as a keyboard, a mouse, a microphone, a touch pad or another input device that is coupled to computing device 10 via user interface 22.

One example of a software application is a camera application. CPU 16 executes the camera application, and in response, the camera application causes camera processor 14 and sensor 12 to generate content for display on display 28. For example, display 28 may output information such as light intensity, whether flash is enabled, and other such information. The user of computing device 10 may interface with display 28 to configure the manner in which the images are generated (e.g., with or without flash, focus settings, exposure settings, and other parameters). The camera application also causes CPU 16 to instruct camera processor 14 to process the images captured by sensor 12 in the user-defined manner. The camera application may further cause display 28 to display images captured by sensor 12 and camera processor 14.

Camera processor 14, CPU 16, and GPU 18 may store image data, and the like, in respective buffers that are allocated within each of camera processor 14, CPU 16, and GPU 18, or within system memory 30. Display interface 26 may retrieve the data from system memory 30 and configure display 28 to display the image represented by the generated image data. In some examples, display interface 26 may include a digital-to-analog converter (DAC) that is configured to convert the digital values retrieved from system memory 30 into an analog signal consumable by display 28. In other examples, display interface 26 may pass the digital values directly to display 28 for processing.

Display 28 may include a monitor, a television, a projection device, a liquid crystal display (LCD), a plasma display panel, a light emitting diode (LED) array, electronic paper, a surface-conduction electron-emitted display (SED), a laser television display, a nanocrystal display or another type of display unit. Display 28 may be integrated within computing device 10. For instance, display 28 may be a screen of a mobile telephone handset or a tablet computer. Alternatively, display 28 may be a stand-alone device coupled to computing device 10 via a wired or wireless communications link. For instance, display 28 may be a computer monitor or flat panel display connected to a personal computer via a cable or wireless link.

Memory controller 24 facilitates the transfer of data going into and out of system memory 30. For example, memory controller 24 may receive memory read and write commands, and service such commands with respect to memory 30 in order to provide memory services for the components in computing device 10. Memory controller 24 is communicatively coupled to system memory 30. Although memory controller 24 is illustrated in the example of computing device 10 of FIG. 1 as being a processing circuit that is separate from both CPU 16 and system memory 30, in other examples, some or all of the functionality of memory controller 24 may be implemented on one or both of CPU 16 and system memory 30.

System memory 30 may store program modules and/or instructions and/or data that are accessible by camera processor 14, CPU 16, and GPU 18. For example, system memory 30 may store user applications (e.g., instructions for the camera application), resulting images from camera processor 14, etc. System memory 30 may additionally store information for use by and/or generated by other components of computing device 10. For example, system memory 30 may act as a device memory for camera processor 14. System memory 30 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some examples, system memory 30 may include instructions that cause camera processor 14, CPU 16, GPU 18, and display interface 26 to perform the functions ascribed to these components in this disclosure. Accordingly, system memory 30 may be a computer-readable storage medium having instructions stored thereon that, when executed, cause one or more processors (e.g., camera processor 14, CPU 16, GPU 18, and display interface 26) to perform various functions.

In some examples, system memory 30 is a non-transitory storage medium. The term “non-transitory” indicates that the storage medium is not embodied in a carrier wave or a propagated signal. However, the term “non-transitory” should not be interpreted to mean that system memory 30 is non-movable or that its contents are static. As one example, system memory 30 may be removed from computing device 10, and moved to another device. As another example, memory, substantially similar to system memory 30, may be inserted into computing device 10. In certain examples, a non-transitory storage medium may store data that can, over time, change (e.g., in RAM).

In accordance with various aspects of the techniques described in this disclosure in more detail below, digital camera 15 may be configured to capture an image and to determine the provenance of the image. The provenance of an image may be the history of the image, such as the location where the image was taken, the date and time where the image was taken, a history of edits to the image, and the like. In particular, determining the provenance of the image includes determining whether the image is real (e.g., a faithful record of a real physical scene). Digital camera 15 may receive an image, generate an image capture profile associated with the image based at least in part on data generated during an image capture process associated with the image, determine whether the image is an authentic image based at least in part on the image capture profile, and, in response to determining that the image is an authentic image, generate a digital signature associated with the image. In this way, digital camera 15 may determine the provenance of the image and may digitally sign the image if digital camera 15 determines that the image is an authentic image.

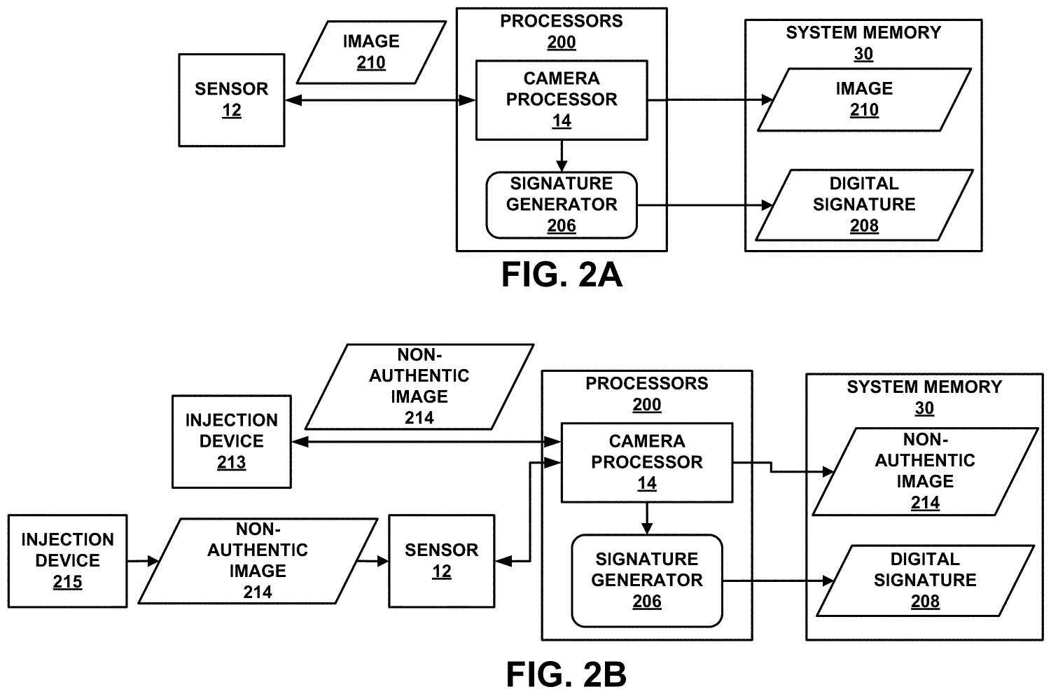

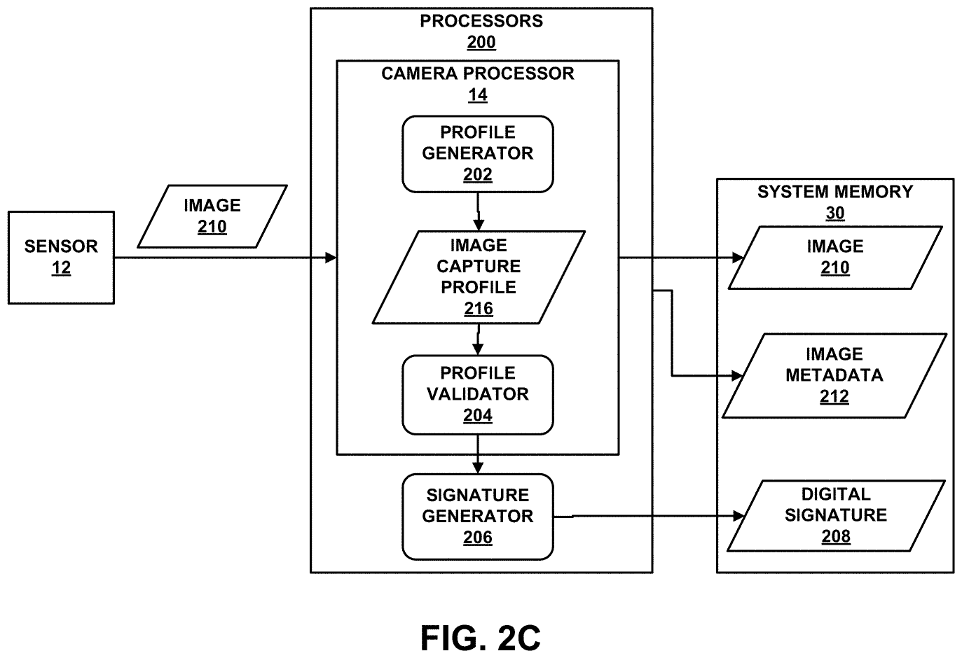

FIGS. 2A-2C illustrate techniques for determining the provenance of an image captured by a digital camera. The techniques disclosed herein for determining the provenance of an image may be performed by processors 200 of computing device 10. Processors 200 may include any combination of camera processor 14, CPU 16, GPU 18, DSP, and/or display interface 26. In some examples, as discussed with respect to FIG. 1, processors 200 be formed on a common integrated circuit chip as a system on a chip.

As shown in FIG. 2A, sensor 12 may be configured to capture image 210 and to send the captured image 210 to camera processor 14. Camera processor 14 as well as other processors of processors 200 may be configured to perform further processing of image 210 for generating a final image for display. For example, processors 200, including camera processor 14 itself, may perform color correction, white balance, blending, compositing, rotation, or other operations to generate the final image content for display. Camera processor 14 may also store image 210 in memory, such as system memory 30.

In response to camera processor 14 receiving image 210 from sensor 12, processors 200 may be configured to execute signature generator 206 to digitally sign image 210 by generating digital signature 208 that processors 200 may store in memory 30. In some examples, signature generator 206 may be software that executes in a trusted execution environment on one of camera processor 14, CPU 16, GPU 18, DSP, and/or display interface 26. In another example, signature generator 206 may be a secure piece of hardware, such as a secure piece of processing circuitry that implements digital signing functionality to digitally sign images.

A digital signature, such as digital signature 208 is a mathematical scheme for verifying the authenticity of digital messages or documents. Public key cryptography, such as Rivest-Shamir-Adleman (RSA), is one common scheme for digitally signing digital content. In public key cryptography, the author of the digital content to be signed may generate a hash of the digital content and may encrypt the hash with a private key to generate the digital signature for the digital content. To verify authorship of the digital content, the verifier of the digital content generates a hash of the digital content, decrypts the encrypted hash from the author using a corresponding public key, and determines whether the hash generated by the verifier matches the decrypted hash.

Accordingly, in some examples, computing device 10 may use the techniques of public key cryptography to digitally sign image 210. In particular, processors 200 may be configured to execute signature generator 206 to digitally sign image 210 by generating a hash of image 210 and encrypting the generated hash with a private key to generate digital signature 208. The private key used to generate digital signature 208 may be a private key associated with processors 200, computing device 10, the manufacturer of computing device 10, the user of computing device 10, and the like. Processors 200 may store the generated digital signature 208 in system memory 30.

While digitally signing image 210 with digital signature 208 may provide verification that image 210 stored in memory 30 is the same image 210 that is received by camera processor 14, digitally signing image 210 with digital signature 208 may not necessarily prove the provenance of image 210. As shown in FIG. 2B, in one example, a malicious party may cause digital camera 15 to capture non-authentic image 214, where non-authentic image 214 is non-authentic because it is not a faithful record of a real physical scene. For example, non-authentic image 214 may be an image of a real physical scene that has been digitally altered for the purposes of deceiving viewers of non-authentic image 214 into believing that non-authentic image 214 is an authentic image that is a faithful record of a real physical scene.

In some examples, a malicious party may digitally alter an image to add one or more people who were not physically present in the scene that the image represents, to remove one or more people who were physically present in the scene that the image represents, digitally alter the characteristics and/or actions of one or more people who were physically present in the scene that the image represents, add one or more objects and/or structures that were not in the real physical scene, remove one or more objects and/or structures present in the real physical scene, digitally alter the characteristics of a real physical scene, and the like.

In another example, non-authentic image 214 may be a computer generated image of a scene that is not a faithful record of a real scene. In another example, non-authentic image 214 may include deep fakes, in which a person in an existing image or video is replaced with someone else's likeness using machine learning techniques.

To cause digital camera 15 to capture non-authentic image 214, the malicious party may hold up a printout of non-authentic image 214 or a mobile device, shown in FIG. 2B as injection device 215 that is displaying an non-authentic image 214, to align the printout or the mobile device's display in the field of view of sensor 12. For example, an unauthorized user may attempt to gain access to computing device 10 via facial recognition by aligning a printout of the face of an authorized user of computing device 10 in the field of view of sensor 12. Because non-authentic image 214 displayed by injection device 215 is captured by sensor 12, security techniques such as on-sensor signing of images captured by sensor 12 may be unable to determine that non-authentic image 214 is not a faithful record of a real physical scene. In another example, a malicious party may send non-authentic image 214 to digital camera 15 by using injection device 213 to access the data bus (e.g., a camera serial interface (C SI)) to processors 200 of computing device 10.

When processors 200 receive non-authentic image 214, the processors 200 may not have any indication that non-authentic image 214 is not a faithful record of a real physical scene captured by sensor 12. As such, processors 200 may execute signature generator 206 to unknowingly digitally sign non-authentic image 214 with digital signature 208, and processor may store non-authentic image 214 and its digital signature 208 in system memory 30, even though non-authentic image 214 is not a faithful record of a real physical scene.

Thus, in accordance with aspects of the present disclosure, computing device 10 may be configured to determine the provenance of an image, including whether an image received by digital camera 15 is an authentic image (e.g., reflects a faithful record of a real physical scene). If computing device 10 determines that the image is an authentic image, computing device 10 may digitally sign the image to indicate that the image is an authentic image. However, if computing device 10 determines that the image is not an authentic image (or is unable to determine whether the image is an authentic image), computing device 100 may refrain from digitally signing the image.

As shown in FIG. 2C, camera processor 14 may include profile generator 202 and profile validator 204 that it may execute to determine whether an image that camera processor 14 is an authentic image. When sensor 12 captures image 210, sensor 12 may send image 210 to camera processor 14. When camera processor 14 receives image 210, camera processor 14 may execute profile generator 202 to determine an image capture profile 216 that is associated with image 210.

In particular, profile generator 202 may execute to determine an image capture profile 216 associated with image 210 based at least in part on data associated with the process of digital camera 15 capturing image 210. In the process of digital camera 15 capturing image 210, sensor 12 and/or camera processor 14 of digital camera 15 may generate and/or determine data that may be used to determine image capture profile 216.

For example, when digital camera 15 is active, sensor 12 may continuously capture a sequence one or more images before it captures image 210 that may be displayed on display 28, such as when display 28 acts as a viewfinder for digital camera 15 by outputting the sequence of images captured by sensor 12. Digital camera 15 may determine the contrast levels and/or brightness levels from the sequence of images and may send sequences of auto exposure and/or auto focus commands to sensor 12 to adjust the exposure and/or focus settings of sensor 12 based on such brightness levels and/or contrast levels. In another example, as sensor 12 captures a sequence one or more images before it captures image 210, digital camera 15 may determine one or more sets of camera sensor metrics of sensor 12 during the process of capturing the sequence of one or more images as well as when sensor 12 captures image 210.

As such, when sensor 12 of digital camera 15 performs the process of capturing an image such as image 210, digital camera 15 may generate and/or receive data associated with the process of capturing image 210. Such data may include the image captured by sensor 12, any additional images captured by additional sensors of digital camera 15 at the same time as image 210 was captured, such as when digital camera 15 includes multiple camera sensors, depth information captured by sensor 12, the brightness and/or contrast of pixels captured by sensor 12, auto exposure and/or auto focus commands sent from camera processor 14, sensor metadata, image metadata, and/or any other suitable data associated with the process of capturing image 210.

Profile generator 202 may execute to generate an image capture profile 216 associated with image 210 that includes indications of such data associated with the process of digital camera 15 capturing image 210. Upon generating image capture profile 216 associated with image 210, camera processor 14 may be configured to execute profile validator 204 to determine, based at least in part on image capture profile 216, the provenance of image 210, including whether image 210 is an authentic image captured by sensor 12 that is, for example, a faithful record of a real physical scene. In particular, profile validator 204 may determine, based at least in part on the data indicated in image capture profile 216, whether image 210 is an authentic image that is captured by sensor 12.

For example, profile validator 204 may determine whether the data associated with the process of digital camera 15 capturing image 210 as indicated in image capture profile 216 is indicative of image 210 being an authentic image captured by sensor 12, such that image 210 is a faithful record of a real physical scene. Profile validator 204 may determine that image capture profile 216 is indicative of image 210 being an authentic image captured by sensor 12 if profile validator 204 determines, for example, that one or more values specified by image capture profile 216 passes one or more specified threshold values.

In some examples, profile validator 204 may determine whether the data associated with the process of digital camera 15 capturing image 210 as indicated in image capture profile 216 corresponds to known ranges of data values of digital camera 15. If profile validator 204 determines that the data indicated in image capture profile 216 is within the known ranges of data values, profile validator 204 may determine that image capture profile 216 is indicative of image 210 being an authentic image. For example, profile validator 204 whether brightness statistics of images captured by sensor 12 corresponds to auto focus commands sent to sensor 12, or whether contrast statistics of images captured by sensor 12 corresponds to auto exposure commands sent to sensor 12. In another example, profile validator 204 may determine whether sensor metrics of sensor 12 corresponds to known sensor metrics of sensor 12. In another example, profile validator 204 may compare image 210 captured by sensor 12 to depth information captured by sensor 12 or additional images captured by additional sensors of digital camera 15 to determine whether image 210 is an authentic image.

In some examples, profile validator 204 may implement one or more machine learning algorithms to determine, based at least in part on image capture profile 216, the provenance of image 210. In one example, profile validator 204 may implement a machine learning classification model, such as a deep neural network. For example, a training system may perform supervised training with labeled data sets that includes image capture profiles associated with authentic images as well as image capture profiles associated with fake images to generate profile validator 204 that is able to classify image capture profiles as being associated with authentic images or being associated with fake images.

In another example, profile validator 204 may implement an unsupervised anomaly detection algorithm, such as a clustering algorithm. For example, a training system may perform unsupervised learning over unlabeled data sets that includes image capture profiles associated with authentic images as well as image capture profiles associated with fake images to detect image capture profiles associated with fake images as anomalies.

If profile validator 204 determines, based at least in part on image capture profile 216, that image 210 is an authentic image captured by sensor 12, camera processor 14 may send an indication of profile validator 204's determination to signature generator 206, and, in response, processors 200 may be configured to execute signature generator 206 to digitally sign image 210 to generate digital signature 208 associated with image 210. By digitally signing image 210, processors 200 indicates that image 210 has been validated as being an authentic image. Camera processor 14 may therefore store image 210 to system memory 30 and processors 200 may also store digital signature 208 associated with image 210 to system memory 30.

In some examples, in addition to digitally signing image 210, signature generator 206 may also be configured to digitally sign image metadata 212 associated with image 210. Image metadata 212 may include information associated with the provenance of image 210, such as the date and/or time that image 210 was captured, the location where image 210 was captured, such as determined via global positioning system, cellular tower location, Wi-Fi information, and the like, a list of processing steps performed on image 210, and the like. In this example, signature generator 206 may digitally sign both image 210 and image metadata 212 to generate digital signature 208, and processors 200 may store image metadata 212 in system memory 30 along with digital signature 208.

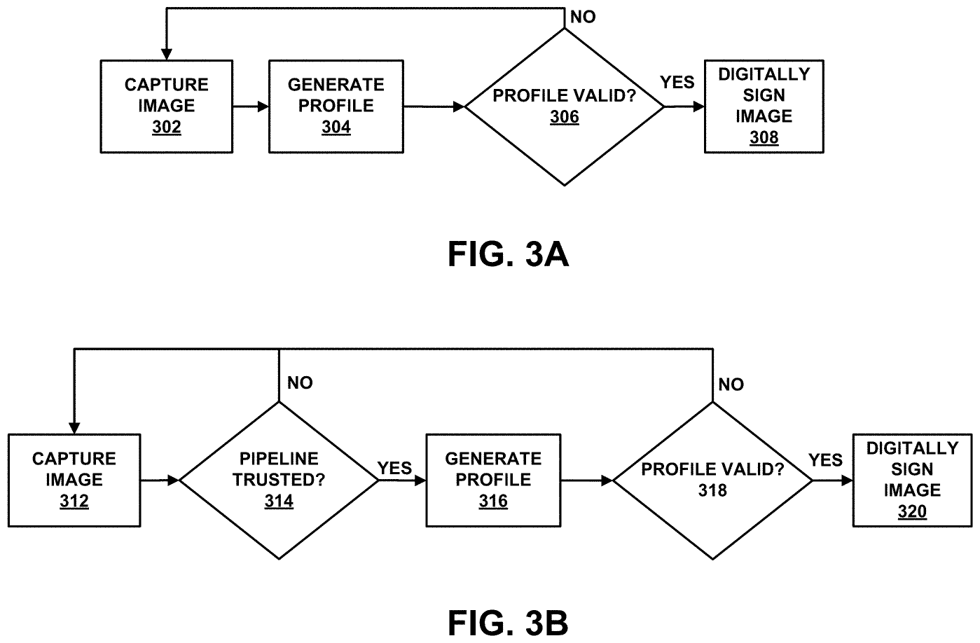

FIGS. 3A and 3B illustrate example methods for determining the provenance of an image. The example methods may be performed by sensor 12, camera processor 14, processors 200, or any other suitable components of computing device 10.

As shown in FIG. 3A, sensor 12 may capture image 210 (302). Camera processor 14 may receive image 210 captured by sensor 12 and may execute profile generator 202 to generate image capture profile 216 associated with image 210 (304). Camera processor 14 may execute profile validator 204 to determine whether image 210 is an authentic image based at least in part on image capture profile 216 (306).

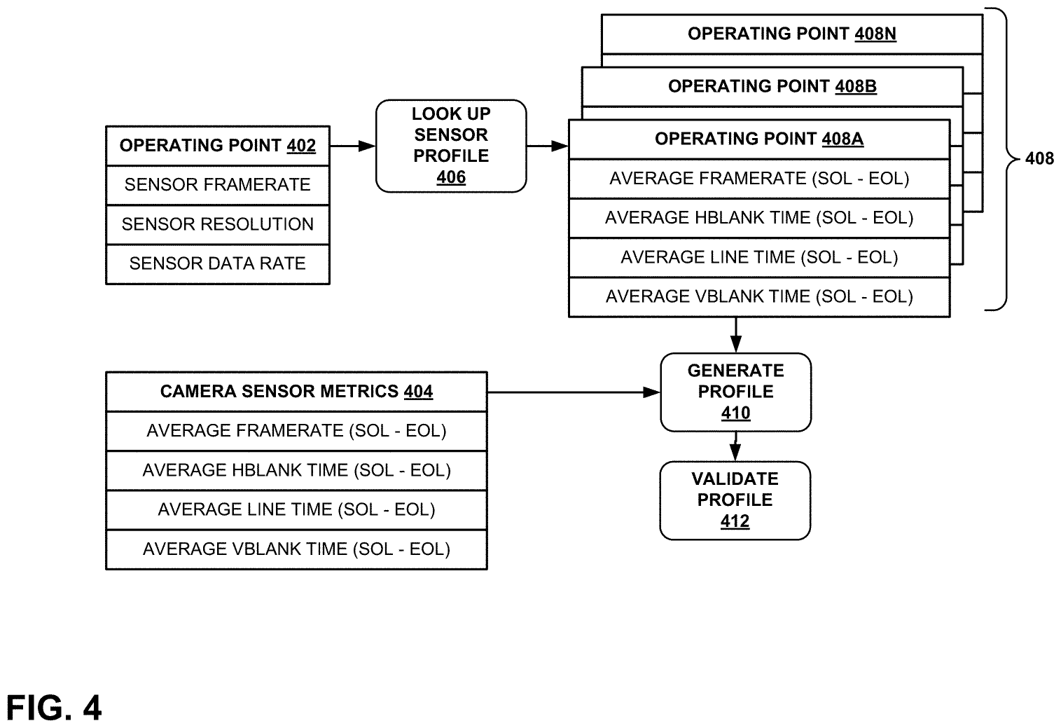

In one example, as described below with respect to FIG. 4, camera processor 14 may determine values of camera sensor metrics of sensor 12 that is operating at a particular operating point and may generate image capture profile 216 that includes indications of the values of the camera sensor metrics of sensor 12. Camera processor 14 may determine the values of a camera sensor profile for camera 15 that corresponds to the particular operating point of sensor 12 and may compare the values of camera sensor metrics of sensor 12 with the values of a camera sensor profile for camera 15 to determine whether the values of the camera sensor metrics are valid values that are indicative of the image being an authentic image. For example, camera processor 14 may determine whether the differences between the values of camera sensor metrics of sensor 12 and values of a camera sensor profile for camera 15 within a specified threshold. In another example, camera processor 14 may determine whether the values of camera sensor metrics of sensor 12 are within a range of values specified by a camera sensor profile for camera 15.

If camera processor 14 determines that image 210 is an authentic image, processors 200 may execute signature generator 206 to digitally sign image 210 (308). Conversely, if camera processor 14 determines that image 210 is not an authentic image, processors 200 may refrain from digitally signing image 210. Instead, camera processor 14 may await a new image that is captured by sensor 12.

In some examples, some aspects of the present disclosure may be predicated on the camera pipeline of computing device 10 being trusted (e.g., being a “secure camera”). A camera pipeline may include processing stages on sensor 12, camera processor 14, and/or processors 200 that execute an image signal processing (ISP) pipeline. If some portions of the camera pipeline is not secure and/or trusted, those portions of the camera pipeline may enable parties such as end users, original equipment manufacturers, independent software vendors, or malicious parties to alter images during processing. As such, in some examples, some aspects of the present disclosure may refrain from digitally signing images if not all portions of the camera pipeline are trusted.

As shown in FIG. 3B, sensor 12 may capture image 210 (312). Camera processor 14 may receive image 210 captured by sensor 12 and may determine if all portions of the camera pipeline are trusted. If camera processor 14 determines that not all portions of the camera pipeline are trusted, camera processor 14 may refrain from generating image capture profile 216 associated with image 210 and determining whether image 210 is an authentic image, and processors 200 may refrain from digitally signing image 210.

If camera processor 14 determines that all portions of the camera pipeline are trusted, camera processor 14 may execute profile generator 202 to generate image capture profile 216 associated with image 210 (316). Camera processor 14 may execute profile validator 204 to determine whether image 210 is an authentic image based at least in part on image capture profile 216 (318). If camera processor 14 determines that image 210 is an authentic image, processors 200 may execute signature generator 206 to digitally sign image 210 (320). On the other hand, if camera processor 14 determines that image 210 is not authentic image, processors 200 may refrain from digitally signing image 210. Instead, camera processor 14 may await a new image that is captured by sensor 12.

In some examples, computing device 10 may determine whether an image is an authentic image captured by sensor 12 based at least in part on camera sensor metrics of sensor 12 as it operates to capture images. Computing device 10 may compare the values of the camera sensor metrics with values of a camera sensor profile for camera 15 to determine whether the values of the camera sensor metrics are valid values that are indicative of the image being an authentic image. In some examples, the camera sensor profile for camera 15 may specify valid ranges of values for the camera sensor metrics, and computing device 10 may determine that values of the camera sensor metrics are valid values if they fall within the ranges of values specified by the camera sensor profile for camera 15. In some examples, the camera sensor profile for camera 15 may specify valid values for the camera sensor metrics, and computing device 10 may determine that values of the camera sensor metrics are valid values if the difference between values of the camera sensor metrics and the values specified by the camera sensor profile for camera 15 are within a specified distance or threshold (e.g., within a specified percentage difference such as 3%, 5%, and the like).

Because the values of such camera sensor metrics of sensor 12 may be dependent at least in part on the operating point of sensor 12, and because sensor 12 may operate in a variety of different operating points, it may be difficult for a malicious party to inject spoofed or otherwise fake values for camera sensor metrics of sensor 12 that correspond to valid values for camera sensor metrics of sensor 12 operating at a particular operating point of sensor 12. As such, camera sensor metrics of sensor 12 may be effective and accurate data that is hard to spoof for determining whether an image is an authentic image captured by sensor 12 with a high degree of reliability.

FIG. 4 illustrates an example technique for generating image capture profile 216 using camera sensor metrics. The example technique described in FIG. 4 may be performed by computing device 10, including any combination of sensor 12, camera processor 14, and/or processors 200 of computing device 10. As shown in FIG. 4, during the process of sensor 12 capturing image 210, sensor 12 may be associated with camera sensor metrics 404. Camera sensor metrics 404 may include low-level camera sensor interface characteristics and/or metrics of sensor 12 during the process of capturing image 210. Such low-level camera sensor interface characteristics and/or metrics may include, for example, an average frame time , an average horizontal blanking interval (HBLANK) time, an average line time, an average vertical blanking interval (VBLANK) time, and the like of a series of frames captured by sensor 12 during the process of capturing image 210.

The average frame time may be the average frame time for a series of frames, where the frame time for a frame is the time between a start-of-frame (SOF) and an end-of-frame (EOF). The average horizontal blanking interval time may be the average horizontal blanking interval time for the series of frames of images, where a horizontal blanking interval may be a time period between the end of one line of a frame and the beginning of a next line of the frame. The average line time may be the average line time for lines in the series of frames of images, where the line time for a line is the time between a start-of-line (SOL) and an end-of-line (EOL) for a line of a frame. The average vertical blanking interval time may be the average of vertical blanking intervals of a series of frames, where a vertical blanking interval may be the time between the end of the final line of a frame and the beginning of the first line of the next frame. Thus, a vertical blanking interval between two frames can be determined as the time of the start of line (SOL) for the later frame of the two frames minus the time of the end of line (EOL) for the earlier frame of two frames.

The values of camera sensor metrics 404 may change depending upon the settings of sensor 12 during operation, referred to herein as an operating point. Because sensor 12 captures image 210 using a particular set of settings, the settings of sensor 12 when capturing image 210 may be referred to as the current operating point 402 of sensor 12 that is associated with image 210. As such, the current values of a set of camera sensor metrics 404 is associated with the current operating point 402 of sensor 12. An operating point of sensor 12 may correspond to a particular set of characteristics or settings of sensor 12 as it operates to capture one or more images. In the example of FIG. 4, the operating point of sensor 12 may include the frame rate of sensor 12, the resolution of sensor 12, and the data rate of sensor 12.

The frame rate of sensor 12 may be the number of images over a period of time (e.g., frames per second) that sensor 12 is able to capture. The resolution of sensor 12 may be the resolution of images that sensor 12 captures. The data rate of sensor 12 may be the rate at which sensor 12 sends data indicative of images it has captured to, for example, camera processor 14. Computing device 10 may determine a current operating point 402 of sensor 12, such as by determining the current frame rate of sensor 12, the current resolution of sensor 12, and/or the current data rate of sensor 12.

A set of camera sensor profiles 408A-408N may be stored in memory, such as system memory 30, of computing device 10, where each camera sensor profile of camera sensor profiles 408A-408N is associated with a particular operating point of sensor 12. Each camera sensor profile of camera sensor profiles 408A-408N includes a set of values for camera sensor metrics of sensor 12 operating at the associated operating point. For example, the camera sensor metrics in each of camera sensor profiles 408A-408N may be the same as camera sensor metrics 404, such as an average frame time, an average horizontal blanking interval time, an average line time, an average vertical blanking interval time, and the like.

Camera sensor profiles 408A-408N may be specific to the operating characteristics of sensor 12 at different operating points. As such, different models and/or brands of cameras having different sensors and different operating characteristics may use camera sensor profiles that specify sets of values or ranges of values for camera sensor metrics that are different from the sets of values or ranges or values specified by camera sensor profile 408A-408N.

Each camera sensor profile of camera sensor profiles 408A-408N may include valid values or valid ranges of values for camera sensor metrics of sensor 12 operating at the associated operating point. Such valid values or valid ranges of values for camera sensor metrics of sensor 12 operating at the associated operating point may correspond to the values or range of values that the camera sensor metrics of sensor 12 would expect to have if it is operating normally to capture images. Thus, to determine whether image 210 received by camera processor 14 is an authentic image, computing device may determine whether the values of camera sensor metrics 404 of sensor 12 that is operating at a current operating point 402 corresponds to the values of camera sensor metrics specified by a camera sensor profile of camera sensor profiles 408A-408N associated with an operating point that corresponds to current operating point 402.

To that end, computing device 10 may use the current operating point 402 of sensor 12 to look up the camera sensor profile of camera sensor profiles 408A-408N associated with an operating point that corresponds to the current operating point 402 of sensor 12 (406). For example, an operating point that corresponds to the current operating point 402 may be an operating point that specifies the same values for the framerate, the resolution, and the data rate as current operating point 402 of sensor 12. In another example, an operating point that corresponds to the current operating point 402 may be an operating point that specifies values for the framerate, the resolution, and the data rate that are the closest to the values for the framerate, the resolution, and the data rate specified current operating point 402 of sensor 12.

In response to determining a camera sensor profile of camera sensor profiles 408A-408N associated with an operating point that corresponds to the current operating point 402 of sensor 12, computing device 10 may generate image capture profile 216 based at least in part on comparing camera sensor metrics 404 with the determined camera sensor profile (410). In some examples, computing device 10 may compare the values of camera sensor metrics 404 with the values determined camera sensor profile and may determine a difference between the values of camera sensor metrics 404 with the values determined camera sensor profile, such as by subtracting the values from each other, and may generate image capture profile 216 that indicates the differences between the values of camera sensor metrics 404 and the values determined camera sensor profile. In another example, if the determined camera sensor profile specifies ranges of values, computing device 10 may determine whether the values of camera sensor metrics 404 fall within the ranges of values in camera sensor profile, and may generate image capture profile 216 that indicates whether the values of camera sensor metrics 404 fall within the ranges of values in camera sensor profile. In some examples, computing device 10 may generate image capture profile 216 that includes indications of the values of camera sensor metrics 404 and the current operating point 402 of camera sensor 12 without comparing camera sensor metrics 404 with the determined camera sensor profile.

Computing device 10 may determine whether image 210 is an authentic image based at least in part on image capture profile 216, such as by validating image capture profile 216 (412). For example, if image capture profile 216 includes indications of the values of camera sensor metrics 404 at a specific operating point of sensor 12, computing device 10 may validate the values of camera sensor metrics 404 by selecting a camera sensor profile of camera sensor profiles 408A-408N associated with the operating point based on the operating point of sensor 12 and by comparing the values of camera sensor metrics indicated by image capture profile 216 against the values of the selected camera sensor profile.

As discussed above, because camera sensor profiles 408A-408N are specific to the operating characteristics of sensor 12, different brands and/or types of cameras with different sensors may be associated with different sensor profiles having different values. Thus, the values of camera sensor profiles may differ depending on the operating characteristics of sensor 12. This may make it more difficult for malicious parties to spoof values for camera sensor metrics 404 because even if a malicious party spoofs values that are valid values when compared with the values of the camera sensor profile for one brand or type of camera and/or sensor, such spoof values may not necessarily be valid values when compared with the values of the camera sensor profile for another brand or type of camera and/or sensor.

In some examples, to compare the values of camera sensor metrics 404 indicated by image capture profile 216 with the values of the camera sensor profile, computing device 10 may determine the difference between the values of camera sensor metrics 404 and the values of the determined camera sensor profile. Computing device 10 may determine whether the difference between the values of camera sensor metrics 404 and the values of the selected camera sensor profile indicates that image 210 is an authentic image, such as by determining if the difference between the values of camera sensor metrics 404 and the values specified by the selected camera sensor profile is less than a specified threshold (e.g., within 3% of each other, within 5% of each other, and the like).

In the example of FIG. 4, computing device 10 may compare the values for the average frame rate, average HBLANK time, average line time, and average VBLANK time specified by camera sensor metrics 404 against the values for the average framerate, average HBLANK time, average line time, and average VBLANK time specified by the camera sensor profile, and may determine that the values specified by camera sensor metrics 404 indicate that image 210 is an authentic image if the differences between each of the values specified by camera sensor metrics 404 and each of the corresponding values specified by the camera sensor profile is less than a specified threshold.

In another example, if the selected camera sensor profile specifies ranges of values, computing device 10 may determine whether the values of camera sensor metrics 404 indicated by image capture profile 216 fall within the ranges of values in camera sensor profile. If computing device 10 determines that the values of camera sensor metrics 404 indicated by image capture profile 216 fall within the ranges of values in camera sensor profile, computing device 10 may determine that the values of camera sensor metrics 404 indicated by image capture profile 216 indicate that image 210 is an authentic image.

In the example of FIG. 4, the camera sensor profile may specify a range of values for each of the average frame rate, average HBLANK time, average line time, and average VBLANK time. Computing device may determine whether each of the values for the average frame rate, average HBLANK time, average line time, and average VBLANK time specified by camera sensor metrics 404 falls within the corresponding range of values specified by the camera sensor profile, and may determine that the values specified by camera sensor metrics 404 indicate that image 210 is an authentic image if each of the values specified by camera sensor metrics 404 falls within the corresponding range of values specified by the camera sensor profile.

In some examples, if image capture profile 216 includes indications of the differences between the values of camera sensor metrics 404 and the values of the camera sensor profile, computing device 10 may determine whether such differences are within a specified threshold and, if so, may successfully validate image capture profile 216 and may determine that image 210 is an authentic image based at least in part on image capture profile 216. In other examples, computing device 10 may implement one or more machine learning algorithms, such as a machine learning classification model or an anomaly detection algorithm as described previously, to determine whether image 210 is an authentic image based at least in part on image capture profile 216.

In some examples, computing device 10 may use depth information of images captured by sensor 12 to determine whether those images are authentic images. As described in FIG. 1, sensor 12 may include PDAF sensors 13 that may capture depth information of images. Not only may it be difficult for malicious parties to generate fake depth information for images, computing device 10 may use such depth information to determine whether it is capturing a three-dimensional physical scene or whether it is capturing a two-dimensional representation of a three-dimensional physical scene, such as a paper print out or a screen shot that is precisely aligned with sensor 12 to depict a fake physical scene. As such, depth information of images captured by PDAF sensors 13 may provide effective and accurate data for determining the provenance of an image, such as image 210, with a high degree of reliability, such as by protecting against spoofing techniques that align an image that depicts a fake physical scene with the field of view of sensor 12.

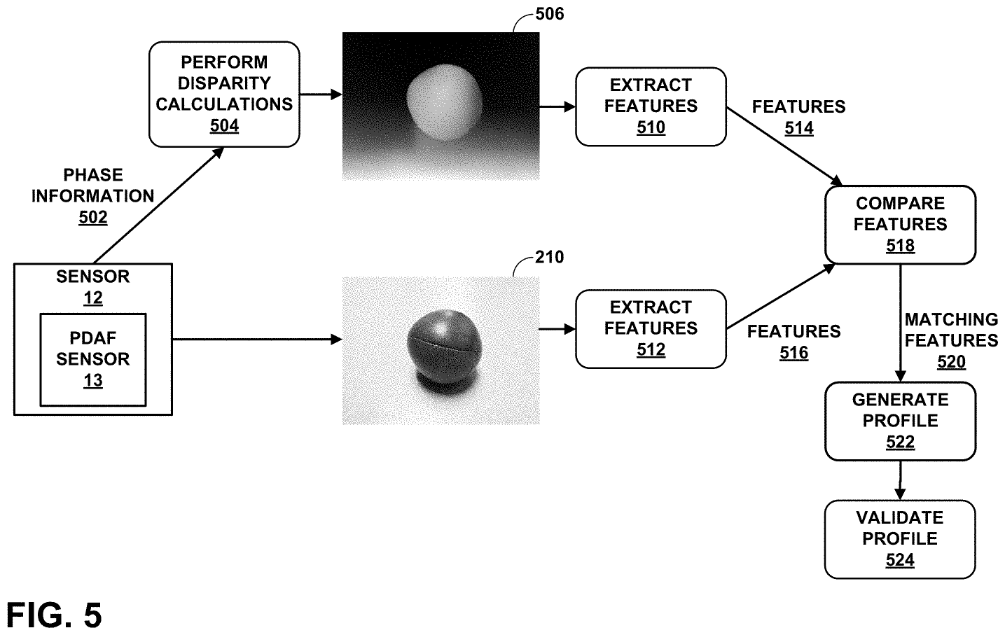

FIG. 5 illustrates an example technique for generating image capture profile 216 using depth information. The example technique described in FIG. 5 may be performed by computing device 10, including any combination of sensor 12, camera processor 14, and/or processors 200 of computing device 10. The example technique described in FIG. 5 may be performed by computing device 10, including any combination of sensor 12, camera processor 14, and/or processors 200 of computing device 10

As shown in FIG. 5, during the process of sensor 12 capturing image 210, data generated during an image capture process of sensor 12 may include phase information 502 associated with image 210 that is captured by sensor 12. Such phase information 502 associated with image 210 may be capture by one or more PDAF sensors 13, which may also be referred to as PDAF pixels, of sensor 12.

Computing device 10 may perform disparity calculations (504) to generate disparity map 506 of image 210 based at least in part on phase information 502, the phase information 502 being determined using one or more PDAF sensors 13. For example, computing device 10 may use phase information 502 to estimate depth values for each pixel of image 210 to generate disparity map 506 of image 210. In some examples, computing device 10 may use a deep neural network or other deep learning techniques to estimate depth values for each pixel of image 210 to generate disparity map 506 of image 210.

A disparity map, such as disparity map 506 and also referred to as a depth map, may record depth information associated with an image, such as image 210. Instead of recording a color value for each pixel in an image, a disparity map may record, for each pixel in the disparity map, a depth value that may indicate the distance of the pixel from the camera sensor, such as sensor 12, that captured the image. Thus, in the example of FIG. 5, disparity map 506 may record depth values for image 210 as disparity map 506.

Computing device 10 may perform feature extraction on disparity map 506 to extract a set of features 514 from disparity map 506 (510). For example, computing device 10 may perform any suitable technique for feature detection for disparity map 506, such as scale-invariant feature transform (SIFT), speeded up robust features (SURF), oriented FAST and rotated BRIEF (ORB), which utilizes the techniques of accelerated segment test (FAST) and Binary Robust Independent Elementary Features (BRIEF), and the like, to extract the set of features 514 from disparity map 506.

To extract the set of features 514 from disparity map 506, computing device 10 may perform keypoint extraction to extract keypoints from disparity map 506, such as by using a deep neural network or other deep learning techniques. Keypoints of an image, such as disparity map 506, are points of interest in the image. A point of interest in the image may be a point at which the direction of the boundary of the object changes abruptly or intersection point between two or more edge segments. Computing device 10 may determine keypoints within disparity map 506 and may determine the spatial locations (e.g., (x, y) coordinates) of such keypoints within disparity map 506.

Computing device 10 may determine features of disparity map 506 based at least in part on the keypoints within disparity map 506. Features of disparity map 506 may include edges, corners, blobs, ridges, and the like. Computing device 10 may also generate feature descriptors for the features of disparity map 506. A feature descriptor for a feature may indicate information regarding the feature that differentiates the feature from other features of the image. For example, a feature descriptor may represent a feature's neighborhood as well as the scale and/or orientation of the feature. In this way, camera processor 14 may determine the set of features 514 as including the features and associated feature descriptors determined from disparity map 506.

Computing device 10 may perform feature extraction on image 210 to extract a set of features 516 from image 210 (512). For example, computing device 10 may perform any suitable technique for feature detection for image 210, such as SIFT, SURF, ORB, and the like to extract the set of features 516 from image 210.

To extract the set of features 516 from image 210, computing device 10 may perform keypoint extraction to extract keypoints from image 210, such as by using a deep neural network or other deep learning techniques. Keypoints of an image, such as image 210, are points of interest in the image. A point of interest in the image may be a point at which the direction of the boundary of the object changes abruptly or intersection point between two or more edge segments. Computing device 10 may determine keypoints within image 210 and may determine the spatial locations (e.g., (x, y) coordinates) of such keypoints within image 210.

Computing device 10 may determine features of image 210 based at least in part on the keypoints within image 210. Features of image 210 may include edges, corners, blobs, ridges, and the like. Computing device 10 may also generate feature descriptors for the features of image 210. A feature descriptor for a feature may indicate information regarding the feature that differentiates the feature from other features of the image. For example, a feature descriptor may represent a feature's neighborhood as well as the scale and/or orientation of the feature. In this way, computing device 10 may determine the set of features 516 as including the features and associated feature descriptors determined from image 210.

Computing device 10 may generate image capture profile 216 (522) based at least in part on comparing the set of features 514 extracted from disparity map 506 with the set of features 516 extracted from image 210 to determine one or more matching features 520 between the set of features 514 and the set of features 516 (518). Comparing the set of features 514 with the set of features 516 may include matching the feature descriptors in the set of features 514 with the feature descriptors in the set of features 516. For example, computing device 10 may define a distance function that compares two feature descriptors and test all of the features in the set of features 514 to find one or more features of the set of features 514 that are each within the distance function of a corresponding features in the set of features 516 as the one or more matching features 520. In some examples, computing device 10 may perform one of the techniques described above, such as SIFT, SURF, or ORB, or other techniques such as Brute-Force Matcher, FLANN (Fast Library for Approximate Nearest Neighbors) Matcher, and the like to determine one or more matching features 520 between the set of features 514 and the set of features 516.

Computing device 10 may generate image capture profile 216 based at least in part on comparing the set of features 514 extracted from disparity map 506 with the set of features 516 extracted from image 210. In particular, computing device 10 may generate image capture profile 216 based at least in part on one or more matching features 520 between the set of features 514 and the set of features 516. For example, image capture profile 216 may include an indication of one or more matching features 520 between the set of features 514 and the set of features 516.

Computing device 10 may determine whether image 210 is an authentic image based at least in part on image capture profile 216, such as by validating image capture profile 216 (524). For example, if image capture profile 216 includes indications of one or more matching features 520 between the set of features 514 and the set of features 516, computing device 10 may determine whether the number of matching features in the set of matching features 516 meets or exceeds a specified threshold and, if so, may successfully validate image capture profile 216 and may determine that image 210 is an authentic image. In other examples, computing device 10 may implement one or more machine learning algorithms, such as a machine learning classification model or an anomaly detection algorithm as described previously, to determine whether image 210 is an authentic image based at least in part on image capture profile 216.

In some examples, computing device 10 may perform contrast-detection auto focus to focus on a point or area. In contrast-detection auto focus, computing device 10 may determine the correct focus on a scene by determining contrast measurements from frames of a scene captured by sensor 12 and by adjusting the focus of sensor 12 based on the contrast measurements. For example, camera processor 14 may determine contrast measurements of an image from sensor 12 and may, in response send one or more auto focus commands to sensor 12 to adjust its focus based on the contrast measurements.

When a camera application executing on CPU 16 is active, sensor 12 may also be active and may continuously capture and send images to camera processor 14, so that, for example, computing device 10 may act as a viewfinder for computing device 10 by outputting the images captured by sensor 12 at display 28. Camera processor 14 may continuously determine contrast measurements for the images and may, in response continuously send auto focus commands to the sensor 12 to adjust its focus based on the contrast measurements. Such a technique may be referred to as contrast-detection auto focus.

Due to the closed loop nature of contrast-detection auto focus in which auto focus commands that camera processor 14 sends to sensor 12 is in response to the contrast measurements of images captured by sensor 12, it may be difficult for a malicious party to generate images with fake contrast corresponding to the auto focus commands that, when measured, can pass for real contrast measurements determined from an image captured by sensor 12 in response to auto focus commands. In particular, in order to generate images with fake contrast corresponding to the auto focus commands that can pass for real contrast measurements in response to auto focus commands that are generated based on the contrast measurements, a malicious party may have to accurately simulate real optical physics of a scene in real time. Further, based on the changes in focus settings, some portions of an authentic image captured by sensor 12 may lighter or darker at a faster or slower rate than other portions of the same image. As such, contrast measurements and corresponding auto focus commands may be effective and accurate data for determining the provenance of an image, such as determining whether image 210 is an authentic image, with a high degree of reliability.

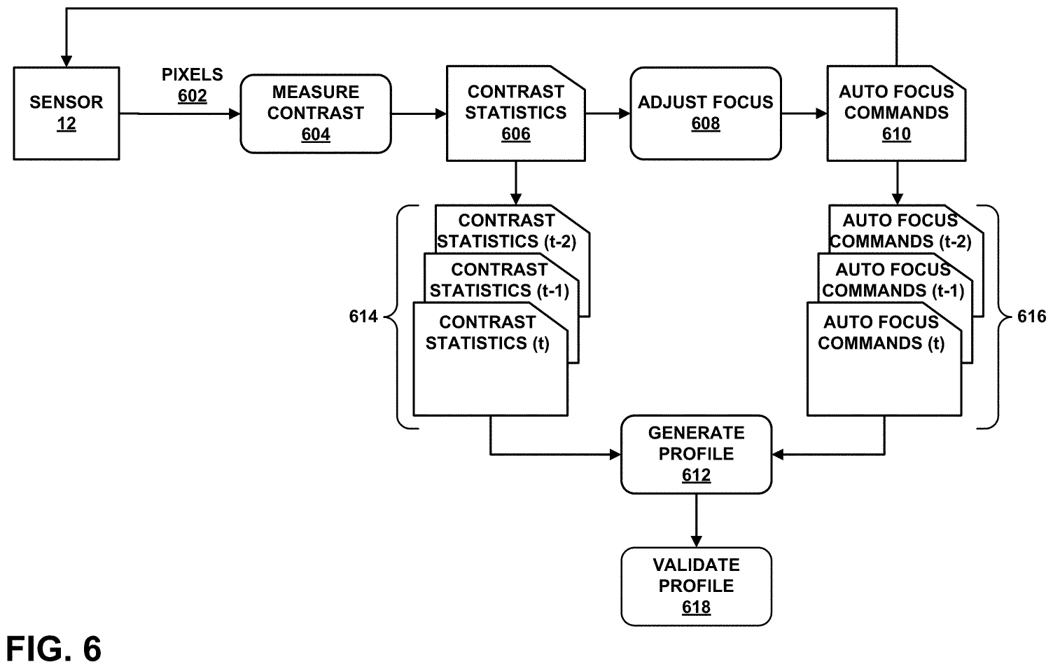

FIG. 6 illustrates an example technique for generating image capture profile 216 using contrast statistics and corresponding auto focus commands. The example technique described in FIG. 6 may be performed by computing device 10, including any combination of sensor 12, camera processor 14, and/or processors 200 of computing device 10.

As shown in FIG. 6, sensor 12 may capture an image and sends pixels 612 of the image to camera processor 14. Camera processor 14 may measure the contrast of pixels 612 (604) to determine contrast statistics 606. Camera processor 14 may use an auto focus algorithm based on the contrast statistics 606 to adjust the focus of sensor 12 (608) by formulating one or more auto focus commands 610 based at least in part on contrast statistics 606, and may send the one or more auto focus commands 610 to sensor 12 to adjust the focus of sensor 12. Sensor 12 may adjust its focus based on the one or more auto focus commands 610. Sensor 12 may subsequently capture another image and send pixels 612 of the image to camera processor 14, thereby starting another sequence of determining contrast statistics 606, formulating one or more auto focus commands 604, and adjusting the focus of sensor 12.

Thus, while computing device 10 is active, camera processor 14 may receive a sequence of images from sensor 12 and may correspondingly generate a sequence of contrast statistics and auto focus commands. To generate image capture profile 216 that is associated with sensor 12 capturing image 210, camera processor 14 may determine the sequence of contrast statistics 614 and the sequence of auto focus commands 616 that is associated with sensor 12 capturing image 210.

The sequence of contrast statistics 614 and the sequence of auto focus commands 616 may interleave each other. For example the sequentially first contrast statistic in the sequence of contrast statistics 614 is followed in time by the sequentially first auto focus command in the sequence of auto focus commands 616 that is generated by camera processor 14 in response to the sequentially first contrast statistic. The sequentially first auto focus command in the sequence of auto focus commands 616 may cause sensor 12 to change its focus settings so that it captures pixels 602 having the sequentially second contrast statistic in the sequence of contrast statistics 614. The sequentially second contrast statistic in the sequence of contrast statistics 614 is followed in time by the sequentially second auto focus command in the sequence of auto focus commands 616 that is generated by camera processor 14 in response to the sequentially first contrast statistics. The sequentially second auto focus command in the sequence of auto focus commands 616 may cause sensor 12 to change its focus settings so that it captures pixels 602 having the sequentially third contrast statistic in the sequence of contrast statistics 614, and so on. As can be seen, in this way, the sequence of contrast statistics 614 may interleave the sequence of auto focus commands 616.

For example, the sequence of contrast statistics 614 and the sequence of auto focus commands 616 that is associated with sensor 12 capturing image 210 may be the sequence of contrast statistics 614 and the sequence of auto focus commands 616 that were generated by camera processor 14 in the N seconds immediately prior to sensor 12 capturing image 210, where N seconds may be 1 second, 5 seconds, 10 seconds, and the like. In another example, the sequence of contrast statistics 614 and the sequence of auto focus commands 616 that is associated with sensor 12 capturing image 210 may be the sequence of contrast statistics 614 and the sequence of auto focus commands 616 that were generated by camera processor 14 in the M most recent images captured by sensor 12 immediately prior to sensor 12 capturing image 210, where M most recent images may be the 5 most recent images, the 10 most recent images, the 30 most recent images, and the like.

Computing device 10 may generate image capture profile 216 that is associated with sensor 12 capturing image 210 based at least in part on the sequence of contrast statistics 614 and the sequence of auto focus commands 616 that is associated with sensor 12 capturing image 210 (612). For example, computing device 10 may generate image capture profile 216 that includes indications c.

Computing device 10 may determine whether image 210 is an authentic image based at least in part on image capture profile 216, such as by validating image capture profile 216 (618). For example, if image capture profile 216 includes indications of the sequence of contrast statistics 614 and the sequence of auto focus commands 616, computing device 10 may determine whether, given the sequence of contrast statistics 614, whether the sequence of auto focus commands 616 are auto focus commands that camera processor 14 would generate in response to receiving the sequence of contrast statistics 614. Similarly, computing device 10 may determine, given the sequence of auto focus commands 616, whether the sequence of contrast statistics 614 corresponds to real contrast measurements determined from images captured by sensor 12 in response to the sequence of auto focus commands 616.

In particular, computing device 10 may determine, for each contrast statistics of the sequence of contract statistics 614, whether camera processor 14 would, in response to receiving the contrast statistic, generate the corresponding auto focus command of the sequence of auto focus commands 616. Similarly, computing device 10 may determine, for each auto focus command of the sequence of auto focus commands 616, whether sensor 12 would, in response to sensor 12 adjusting its focus setting according to the auto focus command, capture pixels 612 that have corresponding contrast statistics of the sequence of contrast statistics 614. In other words, computing device 10 may determine whether the sequence of contrast statistics 614 makes sense for the process of sensor 12 capturing image 210 given the sequence of auto focus commands 616, and vice versa.

In other examples, computing device 10 may implement one or more machine learning algorithms, such as a machine learning classification model or an anomaly detection algorithm as described previously, to determine whether image 210 is an authentic image based at least in part on image capture profile 216.

In some examples, computing device 10 may perform auto exposure to adjust the exposure settings of sensor 12 based on the brightness of the scene. In auto exposure, computing device 10 may determine the exposure settings of sensor 12 by determining brightness measurements from frames of a scene captured by sensor 12 and by adjusting the exposure settings of sensor 12 based on the brightness measurements. For example, camera processor 14 may measure the brightness of an image from sensor 12 and may, in response send one or more auto exposure commands to sensor 12 to adjust its exposure settings based on the determined brightness measurements.

When computing device 10 is active, such as when a camera application executing on CPU 16 is active, sensor 12 may also be active and may continuously capture and send images to camera processor 14, so that, for example, computing device 10 may act as a viewfinder for computing device 10 by outputting the images captured by sensor 12 at display 28. Camera processor 14 may continuously determine brightness measurements for the images and may, in response continuously send auto exposure commands to the sensor 12 to adjust its exposure settings based on the brightness measurements.

Similar to auto focus, due to the closed loop nature of auto exposure in which auto exposure commands that camera processor 14 sends to sensor 12 is in response to the brightness measurements of images captured by sensor 12, it may be difficult for a malicious party to generate images with fake brightness corresponding to the auto exposure commands that, when measured, can pass for real brightness measurements determined by camera processor 14 in response to exposure commands. In particular, in order to generate images with fake brightness corresponding to the auto exposure commands that can pass for real brightness measurements in response to real auto exposure commands that are generated based on the brightness measurements, a malicious party may have to accurately simulate real optical physics of a scene in real time. Further, based on the changes in focus settings, some portions of an authentic image captured by sensor 12 may brighter or darker at a faster or slower rate than other portions of the same image depending on how well lit the portions of the scene captured in the image are. As such, brightness measurements and corresponding auto exposure commands may be effective and accurate data for determining the provenance of an image, such as image 210, with a high degree of reliability.

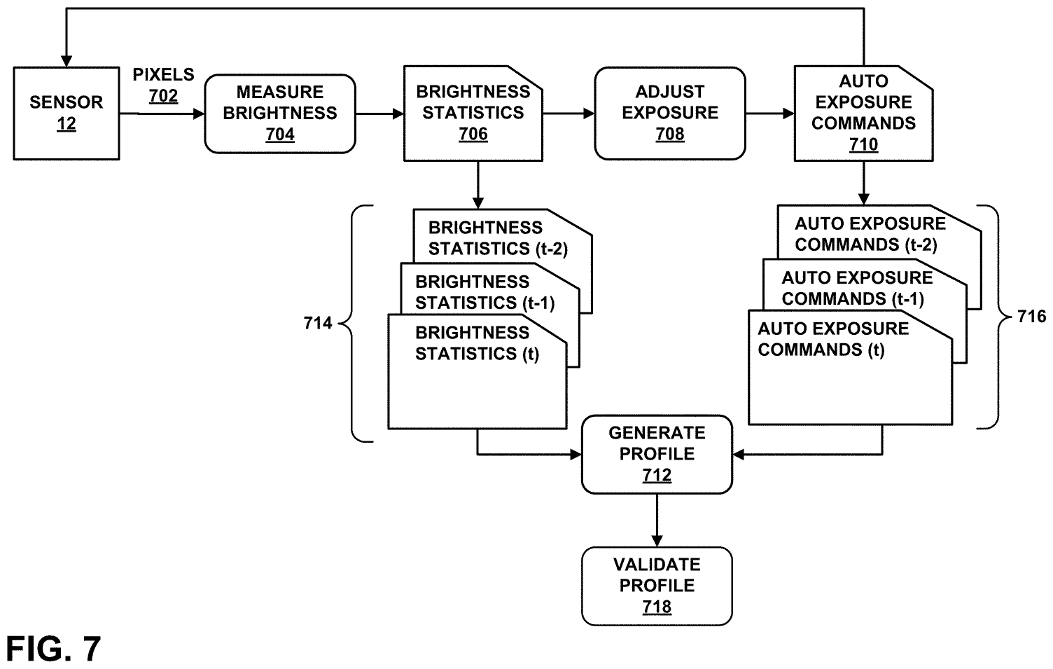

FIG. 7 illustrates an example technique for generating image capture profile 216 using brightness measurements and corresponding auto exposure commands. The example technique described in FIG. 7 may be performed by computing device 10, including any combination of sensor 12, camera processor 14, and/or processors 200 of computing device 10.

As shown in FIG. 7, sensor 12 may capture an image and sends pixels 712 of the image to camera processor 14. Camera processor 14 may measure the brightness of pixels 712 (704) to determine brightness statistics 706. Camera processor 14 may use an auto exposure algorithm based on the brightness statistics 706 to adjust the exposure settings of sensor 12 (708) by formulating one or more auto exposure commands 710 based at least in part on brightness statistics 706, and may send the one or more auto exposure commands 710 to sensor 12 to adjust the focus of sensor 12. Sensor 12 may adjust its focus based on the one or more auto exposure commands 710. Sensor 12 may subsequently capture another image and send pixels 702 of the image to camera processor 14, thereby starting another sequence of determining brightness statistics 706, formulating one or more auto exposure commands 710, and adjusting the focus of sensor 12.

Thus, while computing device 10 is active, camera processor 14 may receive a sequence of images from sensor 12 and may correspondingly generate a sequence of brightness statistics and auto exposure commands. To generate image capture profile 216 that is associated with sensor 12 capturing image 210, camera processor 14 may determine the sequence of brightness statistics 714 and the sequence of auto exposure commands 716 that is associated with sensor 12 capturing image 210.

The sequence of brightness statistics 714 and the sequence of auto exposure commands 716 may interleave each other. For example the sequentially first brightness statistic in the sequence of brightness statistics 714 is followed in time by the sequentially first auto exposure command in the sequence of auto exposure commands 716 that is generated by camera processor 14 in response to the sequentially first brightness statistic. The sequentially first auto exposure command in the sequence of auto exposure commands 716 may cause sensor 12 to change its exposure settings so that it captures pixels 602 having the sequentially second brightness statistic in the sequence of brightness statistics 714. The sequentially second brightness statistic in the sequence of brightness statistics 714 is followed in time by the sequentially second auto exposure command in the sequence of auto exposure commands 716 that is generated by camera processor 14 in response to the sequentially first brightness statistics. The sequentially second auto exposure command in the sequence of auto exposure commands 716 may cause sensor 12 to change its exposure settings so that it captures pixels 602 having the sequentially third brightness statistic in the sequence of brightness statistics 714, and so on. As can be seen, in this way, the sequence of brightness statistics 714 may interleave the sequence of auto exposure commands 716.

For example, the sequence of brightness statistics 714 and the sequence of auto exposure commands 716 that is associated with sensor 12 capturing image 210 may be the sequence of brightness statistics 714 and the sequence of auto exposure commands 716 that were generated by camera processor 14 in the N seconds immediately prior to sensor 12 capturing image 210, where N seconds may be 1 second, 5 seconds, 10 seconds, and the like. In another example, the sequence of brightness statistics 714 and the sequence of auto exposure commands 716 that is associated with sensor 12 capturing image 210 may be the sequence of brightness statistics 714 and the sequence of auto exposure commands 716 that were generated by camera processor 14 in the M most recent images captured by sensor 12 immediately prior to sensor 12 capturing image 210, where M most recent images may be the 5 most recent images, the 10 most recent images, the 30 most recent images, and the like.

Computing device 10 may generate image capture profile 216 that is associated with sensor 12 capturing image 210 based at least in part on the sequence of brightness statistics 714 and the sequence of auto exposure commands 716 that is associated with sensor 12 capturing image 210 (712). For example, computing device 10 may generate image capture profile 216 that includes indications of the sequence of brightness statistics 714 and the sequence of auto exposure commands 716.

Computing device 10 may determine whether image 210 is an authentic image based at least in part on image capture profile 216, such as by validating image capture profile 216 (718). For example, if image capture profile 216 includes indications of the sequence of brightness statistics 714 and the sequence of auto exposure commands 716, computing device 10 may determine whether, given the sequence of brightness statistics 714, whether the sequence of auto exposure commands 716 are auto focus commands that camera processor 14 would generate in response to receiving sequence of brightness statistics 714. Similarly, computing device 10 may determine, given the sequence of auto exposure commands 716, whether the sequence of brightness statistics 714 corresponds to real brightness measurements determined from images captured by sensor 12 in response to the sequence of auto exposure commands 716

In particular, computing device 10 may determine, for each brightness statistic of the sequence of brightness statistics 714, whether camera processor 14 would, in response to receiving the brightness, generate the corresponding auto exposure command of the sequence of auto exposure commands 716. Similarly, computing device 10 may determine, for each auto exposure command of the sequence of auto exposure commands 716, whether sensor 12 would, in response to sensor 12 adjusting its focus setting according to the auto exposure command, capture pixels 712 that have corresponding brightness statistics of the sequence of brightness statistics 714. In other words, computing device 10 may determine whether the sequence of brightness statistics 714 makes sense for the process of sensor 12 capturing image 210 given the sequence of auto exposure commands 716, and vice versa.

In other examples, computing device 10 may implement one or more machine learning algorithms, such as a machine learning classification model or an anomaly detection algorithm as described previously, to determine whether image 210 is an authentic image based at least in part on image capture profile 216.

In some examples, computing device 10 may include multiple camera sensors for capturing images. Having multiple camera sensors may enable computing device 10 to use its multiple cameras sensors to simultaneously capture multiple images of the same scene from different angles and/or with different fields of view. For example, if computing device 10 includes a telephoto sensor and a wide angle sensor, the telephoto sensor may capture a zoomed in image of a scene while the wide angle sensor simultaneously captures a wide angle image of the same scene.

When computing device 10 uses multiple camera sensors to simultaneously capture multiple images of the same scene, computing device 10 may determine the provenance of one of the images of a scene captured by one of the multiple sensors of digital camera 15 (e.g., whether the image is an authentic image) based at least in part on comparing the image with the other one or more images of the same scene captured by the other one or more camera sensors. Because it may be relatively difficult to fake a scene from multiple angles and/or fields of view, computing device 10 may be able to determine the provenance of one of the multiple images of the same scene by comparing the image with the other one or more images of the same scene captured by the one or more other camera sensors of computing device 10. As such, the use of multiple camera sensors to simultaneously capture multiple images of the same scene may enable computing device 10 to determine the provenance of an image, such as image 210, with a high degree of reliability.

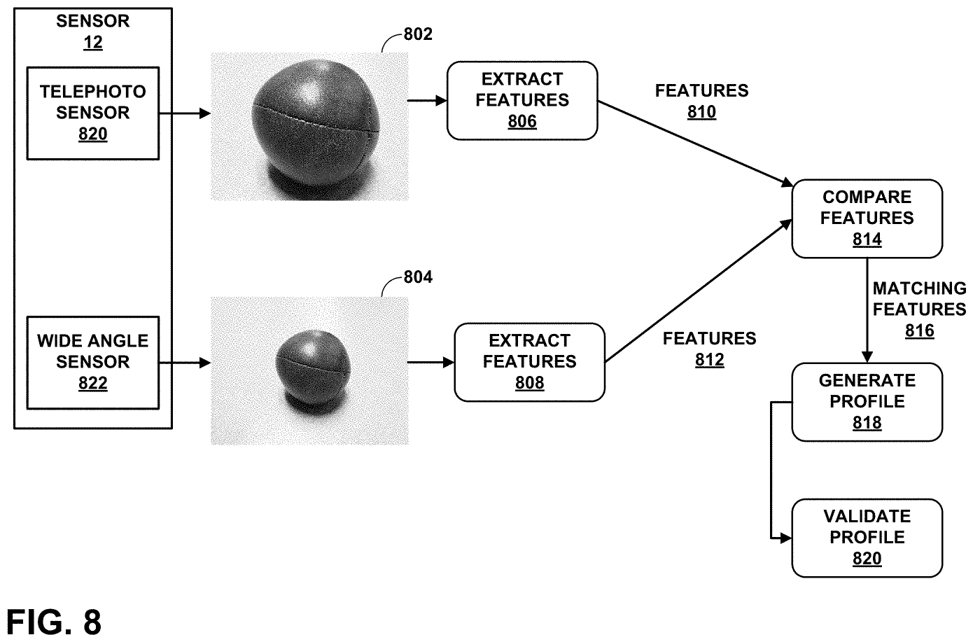

FIG. 8 illustrates an example technique for generating image capture profile 216 using images captured by multiple camera sensors. The example technique described in FIG. 8 may be performed by computing device 10, including any combination of sensor 12, camera processor 14, and/or processors 200 of computing device 10.

As shown in FIG. 8, computing device 10 includes two camera sensors: telephoto sensor 820 and wide angle sensor 822. While computing device 10 in the technique illustrated in FIG. 8 makes use of two sensors (telephoto sensor 820 and wide angle sensor 822), the techniques illustrated herein are equally applicable to any other camera devices having two or more sensors, including camera devices having camera sensors, such as a stereo sensor, other than a telephoto sensor or a wide angle sensor.

Telephoto sensor 820 may capture image 802 of a scene while wide angle sensor 822 may capture image 804 of the same scene at the same time as telephoto sensor 820 captures image 802. As discussed above, because multiple camera sensors, such as telephoto sensor 820 and wide angle sensor 822 may have different angles different fields of view, and other differing characteristics, although image 802 and image 804 are images of the same scene captured at the same time, image 802 and image 804 are not identical images.

Nevertheless, despite image 802 and image 804 being different, the features of image 802 may be similar to the features of images 804 because they are both images of the same scene captured at the same time. As such, computing device 10 may be able to extract features from each of image 802 and image 804 and compare the features that are extracted to determine the provenance of image 802 and/or image 804.

Camera processor 14 may perform feature extraction on image 802 to extract a set of features 810 (806). For example, camera processor 14 may perform any suitable technique for feature detection for image 802, such as scale-invariant feature transform (SIFT), speeded up robust features (SURF), oriented FAST and rotated BRIEF (ORB), which utilizes the techniques of accelerated segment test (FAST) and Binary Robust Independent Elementary Features (BRIEF), and the like, to extract the set of features 810 from image 82.

In some examples, to extract the set of features 810 from image 802, camera processor 14 may perform keypoint extraction to extract keypoints from image 802, such as by using a deep neural network or other deep learning techniques. Keypoints of an image, such as image 802, are points of interest in the image. A point of interest in the image may be a point at which the direction of the boundary of the object changes abruptly or intersection point between two or more edge segments. Camera processor 14 may determine keypoints within image 802 and may determine the spatial locations (e.g., (x, y) coordinates) of such keypoints within image 802.

Camera processor 14 may determine features of image 802 based at least in part on the keypoints within image 802. Features of image 802 may include edges, corners, blobs, ridges, and the like. Camera processor 14 may also generate feature descriptors for the features of image 802. A feature descriptor for a feature may indicate information regarding the feature that differentiates the feature from other features of the image. For example, a feature descriptor may represent a feature's neighborhood as well as the scale and/or orientation of the feature. In this way, camera processor 14 may determine the set of features 810 as including the features and associated feature descriptors determined from image 802.

Similarly, camera processor 14 may perform feature extraction on image 804 to extract a set of features 812 from image 804 (808). For example, camera processor 14 may perform any suitable technique for feature detection for image 804, such as SIFT, SURF, ORB, and the like to extract the set of features 812 from image 804.

To extract the set of features 812 from image 804, camera processor 14 may perform keypoint extraction to extract keypoints from image 804, such as by using a deep neural network or other deep learning techniques. Keypoints of an image, such as image 804, are points of interest in the image. A point of interest in the image may be a point at which the direction of the boundary of the object changes abruptly or intersection point between two or more edge segments. Camera processor 14 may determine keypoints within image 804 and may determine the spatial locations (e.g., (x, y) coordinates) of such keypoints within image 804.

Camera processor 14 may determine features of image 804 based at least in part on the keypoints within image 804. Features of image 804 may include edges, corners, blobs, ridges, and the like. Camera processor 14 may also generate feature descriptors for the features of image 804. A feature descriptor for a feature may indicate information regarding the feature that differentiates the feature from other features of the image. For example, a feature descriptor may represent a feature's neighborhood as well as the scale and/or orientation of the feature. In this way, camera processor 14 may determine the set of features 812 as including the features and associated feature descriptors determined from image 804.

Computing device 10 may generate image capture profile 216 (818) based at least in part on comparing the set of features 810 extracted from image 802 with the set of features 812 extracted from image 804 to determine one or more matching features 816 between the set of features 810 and the set of features 812 (814). Comparing the set of features 810 with the set of features 812 may include matching the feature descriptors in the set of features 810 with the feature descriptors in the set of features 812. For example, computing device 10 may define a distance function that compares two feature descriptors and test all of the features in the set of features 810 to find one or more features of the set of features 810 that are each within the distance function of a corresponding features in the set of features 812 as the one or more matching features 816. In some examples, computing device 10 may perform one of the techniques described above, such as SIFT, SURF, or ORB, or other techniques such as Brute-Force Matcher, FLANN (Fast Library for Approximate Nearest Neighbors) Matcher, and the like to determine one or more matching features 816 between the set of features 810 and the set of features 812.

Computing device 10 may generate image capture profile 216 based at least in part on comparing the set of features 810 extracted from image 802 with the set of features 812 extracted from image 804. In particular, computing device 10 may generate image capture profile 216 based at least in part on one or more matching features 816 between the set of features 810 and the set of features 812. For example, image capture profile 216 may include an indication of one or more matching features 816 between the set of features 810 and the set of features 812.

Computing device 10 may determine whether image 210 (e.g., image 802 or image 804) is an authentic image based at least in part on image capture profile 216, such as by validating image capture profile 216 (820). For example, if image capture profile 216 includes indications of one or more matching features 816 between the set of features 810 and the set of features 812, computing device 10 may determine whether the number of matching features in the set of matching features 816 meets or exceeds a specified threshold and, if so, may successfully validate image capture profile 216 and may determine that image 210 is an authentic image. In other examples, computing device 10 may implement one or more machine learning algorithms, such as a machine learning classification model or an anomaly detection algorithm as described previously, to determine whether image 210 is an authentic image based at least in part on image capture profile 216.

In some examples, computing device 10 may use any combinations of the techniques disclosed herein, such as techniques described in FIGS. 4-8 or elsewhere, to generate image capture profile 216 for an image, such as image 210 and to determine image 210's provenance based at least in part on its image capture profile 216. Further, in some examples, computing device 10 may use machine learning to generate image capture profile 216 based on any such combinations of the techniques described in FIGS. 4-8. By using a combination of the techniques described in FIGS. 4-8, computing device 10 may potentially be able to increase the reliability and accuracy of its determination of image 210's provenance compared with using a single one of the techniques described in FIGS. 4-8.

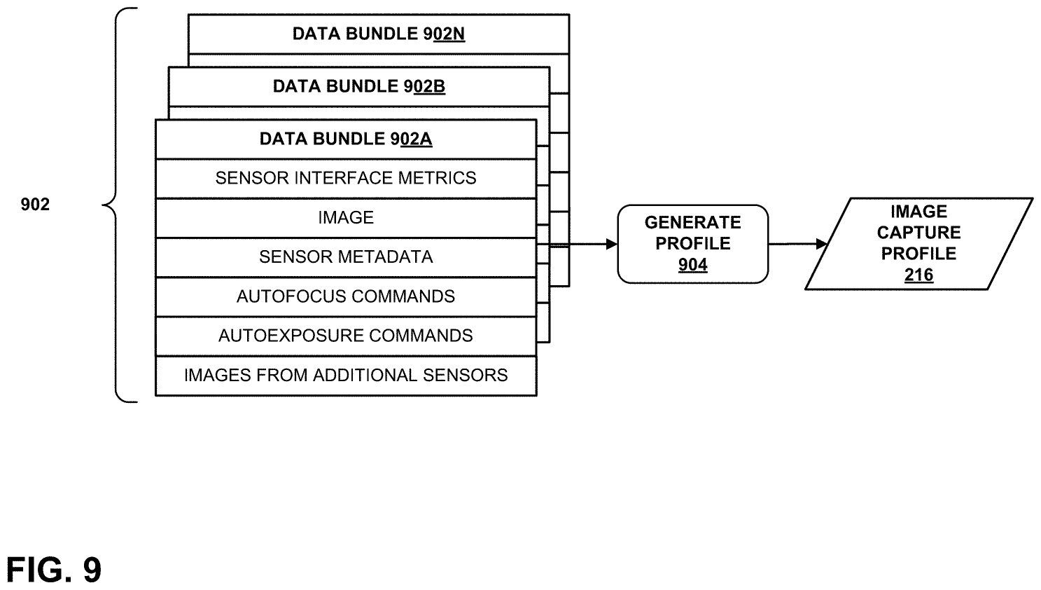

FIG. 9 illustrates additional techniques for generating image capture profile 216. The example techniques described in FIG. 9 may be performed by computing device 10, including any combination of sensor 12, camera processor 14, and/or processors 200 of computing device 10.

As shown in FIG. 9, camera processor 14 may determine and/or receive from sensor 12 a set of data bundles 902A-902N (“data bundles 902”) associated with sensor 12 capturing image 210. Data bundles 902 may be sequences of data generated during an image capture process of sensor 12 over time. For example, each data bundle of data bundles 902 (e.g., data bundle 902A) may be associated with one of a series of images captured by sensor 12 during the process of sensor 12 capturing image 210. For example, each data bundle of data bundles 902 may include camera sensor interface metrics such as camera sensor metrics 404 in the example technique illustrated in FIG. 4, the image associated with the data bundle in the series of images captured by sensor 12, an additional image captured at the same time by another camera sensor of computing device 10, such as in the example technique illustrated in FIG. 8, sensor metadata associated with sensor 12, a sequence of contrast statistics 614 and a sequence of auto focus commands 616 generated by camera processor 14, such as in the example technique illustrated in FIG. 6, a sequence of brightness statistics 714 and a sequence of auto exposure commands 716 generated by camera processor 14, such as illustrated in the example technique illustrated in FIG. 7, and the like.

Computing device 10 may generate image capture profile 216 (904) based at least in part on data bundles 902. In some examples, computing device 10 may implement a deep neural network that performs neural feature extraction on data bundles 902 to extract features from data bundles 902, so that image capture profile 216 may include an indication of the features extracted from data bundles 902. Such a deep neural network may be trained on datasets that include real data bundles (e.g., data bundles associated with authentic images) and fake data bundles (e.g., data bundles associated with fake images) in order to perform neural feature extraction on data bundles 902 to extract features that would be relevant to determining whether image 210 is an authentic image.

Computing device 10 may determine whether image 210 (e.g., image 802 or image 804) is an authentic image based at least in part on image capture profile 216, such as by validating image capture profile 216 (906). For example, computing device 10 may implement one or more machine learning algorithms, such as a machine learning classification model or an anomaly detection algorithm as described previously, to determine whether image 210 is an authentic image based at least in part on image capture profile 216.

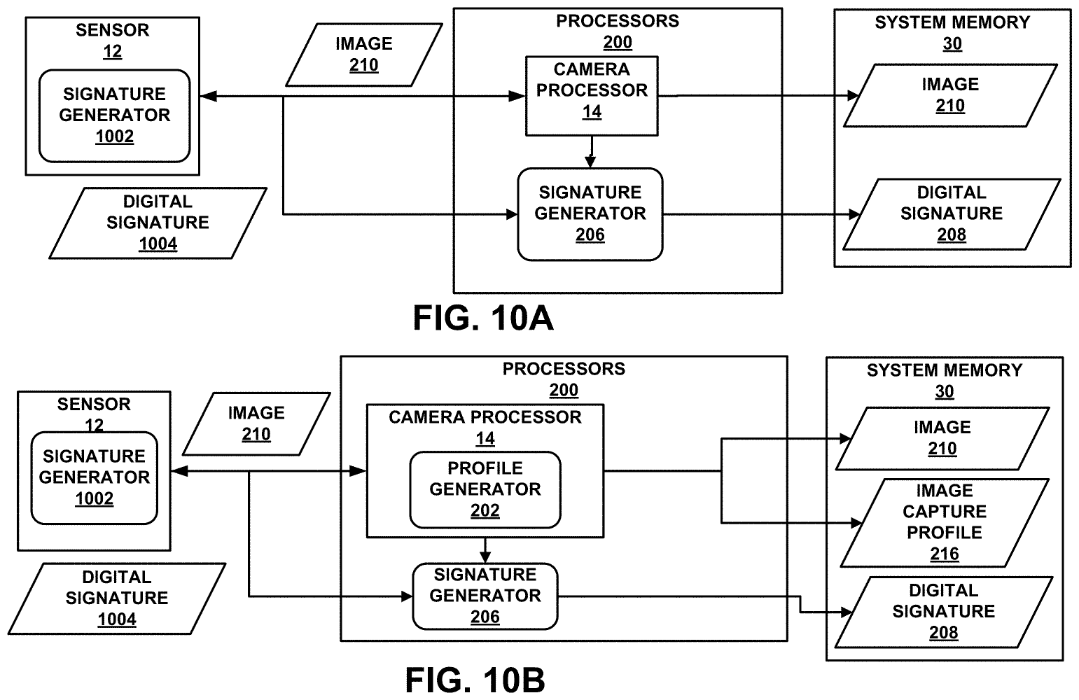

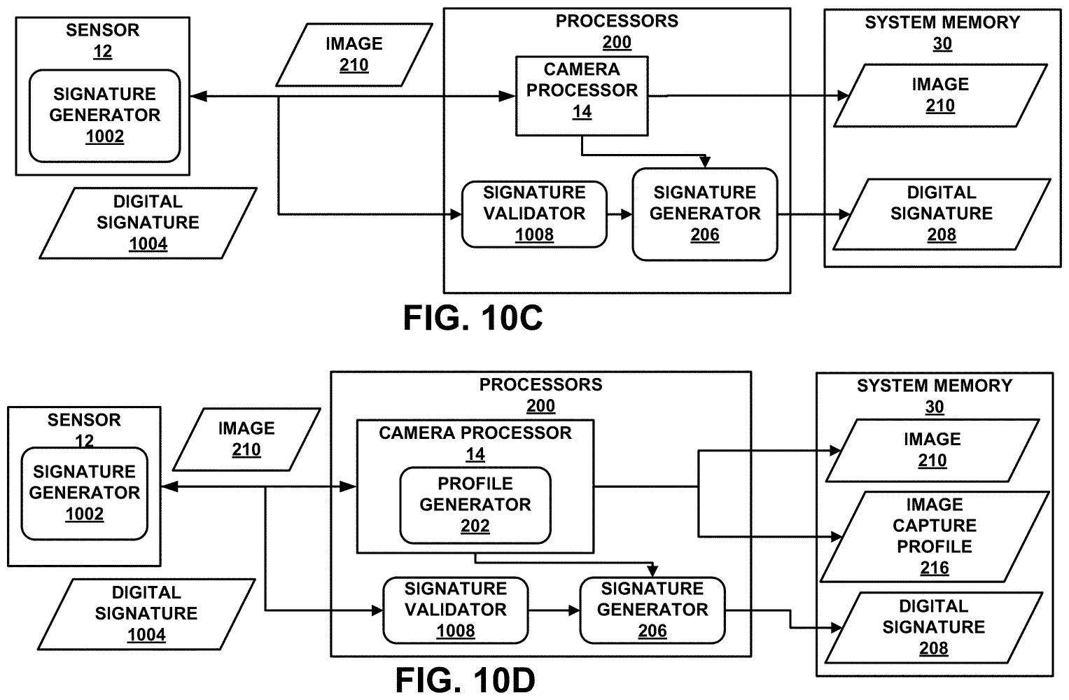

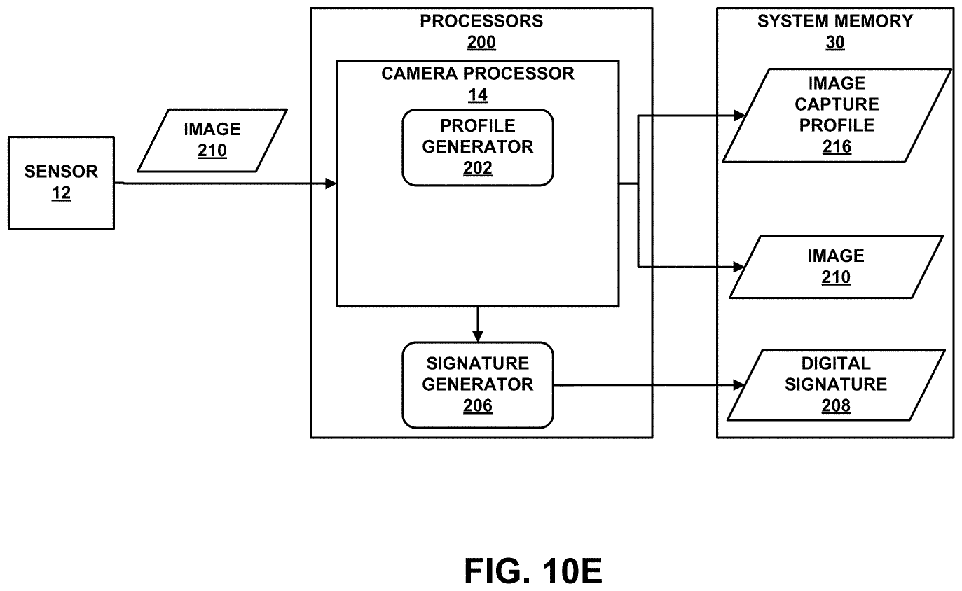

FIGS. 10A-10E illustrate additional techniques for determining the provenance of an image captured by a digital camera. As shown in FIG. 10A, sensor 12 may include signature generator 1002 that is similar to signature generator 206 of FIGS. 2A-2C. When sensor 12 captures image 210, sensor 12 may be configured to execute signature generator 1002 to digitally sign image 210 to generate digital signature 1004 associated with image 210. By digital signing image 210, sensor 12 indicates that image 210 is an image captured by sensor 12.

Sensor 12 may be configured to transmit image 210 and digital signature 1004 to processors 200. For example camera processor 14 may be configured to perform any image processing of image 210. Further, processors 200 may execute signature generator 206 to digitally sign both image 210 and digital signature 1004 to generate digital signature 208 that is associated with both image 210 and digital signature 1004. Processors 200 may store both image 210 and digital signature 208 in system memory 30. As can be seen in the example of FIG. 10A, processors 200 may not necessarily generate an image capture profile, such as image capture profile 216 that is associated with image 210, in order to determine the provenance of image 210.

As shown in FIG. 10B, in some examples, camera processor 14 may be configured to generate image capture profile 216 of image 210 that is digitally signed by sensor 12. For example, camera processor 14 may be configured to execute profile generator 202 to generate image capture profile 216 associated with image 210 using any of the example techniques disclosed herein, such as the techniques illustrated in FIGS. 4-9. Camera processor 14 may be configured to store image capture profile 216 in system memory 30 along with image 210 and digital signature 208. In some examples, because image capture profile 216 is created and stored in system memory 30, image capture profile 216 can be later forensically analyzed for after-the-fact authentication of image 210.

As shown in FIG. 10C, in some examples, processors 200 may validate digital signature 1004 generated by sensor 12 digitally signing image 210 before processors 200 digitally signs digital signature 1004 and image 210. For example, in response to receiving digital signature 1004, processors 200 may execute signature validator 1008 to validate digital signature 1004. For example, signature validator 1008 may execute to decrypt digital signature 1004 with a public key that corresponds to the private key used by sensor 12 to generate digital signature to produce a decrypted hash. Signature validator 1008 may generate a hash of image 210 and may compare the hash of image 210 with the decrypted hash to determine whether the hash of image 210 matches the decrypted hash. If the hash of image 210 matches the decrypted has, signature validator 1008 may execute to determine that digital signature 1004 is valid.

If processors 200 determine that digital signature 1004 is a valid digital signature associated with image 210, processors 200 may execute signature generator 206 to digitally sign both image 210 and digital signature 1004 to generate digital signature 208 that is associated with both image 210 and digital signature 1004. Processors 200 may store both image 210 and digital signature 208 in system memory 30. Conversely, if processors 200 determines that digital signature 1004 is not a valid digital signature associated with image 210, processors 200 may refrain from digitally signing image 210 and digital signature 1004 and may refrain from generating digital signature 208.

As shown in FIG. 10D, in some examples, camera processor 14 may be configured to generate image capture profile 216 of image 210 that is digitally signed by sensor 12. For example, camera processor 14 may be configured to execute profile generator 202 to generate image capture profile 216 associated with image 210 using any of the example techniques disclosed herein, such as the techniques illustrated in FIGS. 4-9. Camera processor 14 may be configured to store image capture profile 216 in system memory 30 along with image 210 and digital signature 208. In some examples, because image capture profile 216 is created and stored in system memory 30, image capture profile 216 can be later forensically analyzed for after-the-fact authentication of image 210.

In some examples, computing device 10 may simply generate image capture profile 216 associated with image 210 without verifying whether image 210 is an authentic image. For example, sensor 12 may not digitally sign image 210 and processors 200 may not determine, based on the image capture profile 216, whether image 210 is an authentic image. Instead, as shown in FIG. 10E, computing device 10 may generate and store image capture profile 216 in system memory 30 along with image 210 so that image capture profile 216 can be later forensically analyzed for after-the-fact authentication of image 210.

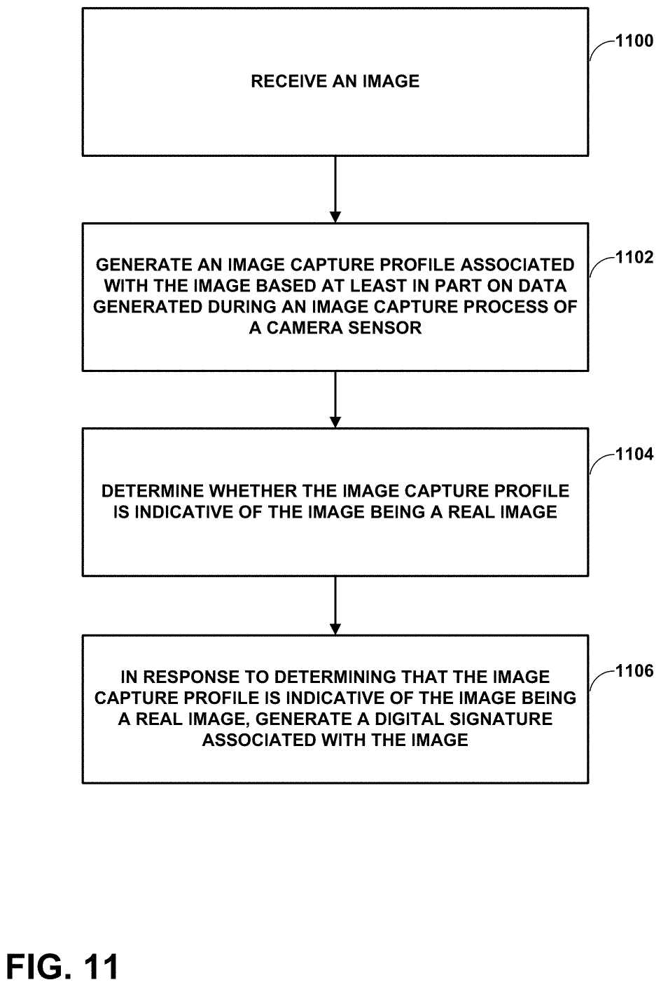

FIG. 11 is flowchart illustrating an example method according to the disclosure. The techniques of FIG. 11 may be performed by computing device 10, including any combination of sensor 12, camera processor 14, and/or processors 200 of computing device 10.

In one example of the present disclosure, camera processor 14 may receive an image 210 (1100). For example, camera processor 14 may receive image 210 from camera sensor 12.

Camera processor 14 may generate an image capture profile 216 associated with the image 210 based at least in part on data generated during an image capture process of a camera sensor 12 (1102). In some examples, camera processor 14 may determine camera sensor metrics 404 associated with a current operating point 402 of the camera sensor 12. Camera processor 14 may determine, out of a plurality of camera sensor profiles 408 associated with a plurality of different operating points, a camera sensor profile associated with an operating point that corresponds to the current operating point 402 of the camera sensor 12. Camera processor 14 may generate the image capture profile 216 based at least in part on comparing the camera sensor metrics 404 with the camera sensor profile.

In some examples, camera processor 14 may determine a disparity map 506 of the image 210 based at least in part on phase information 502 of the image 210 determined using one or more phase-detection auto focus (PDAF) sensors 13 of the camera sensor 12. Camera processor 14 may extract a first set of features 514 from the disparity map 506 of the image 210. Camera processor 14 may extract a second set of features 516 from the image 210 captured by the camera sensor 12. Camera processor 14 may compare the first set of features 514 and the second set of features 516 to determine one or more matching features 520 between the first set of features 514 and the second set of features 516. Camera processor 14 may generate the image capture profile 216 based at least in part on the one or more matching features 520 between the first set of features 514 and the second set of features 516.

In some examples, camera processor 14 may determine a sequence of contrast statistics 614 associated with the image capture process of the camera sensor 12. Camera processor 14 may determine a sequence of auto focus commands 616 associated with the image capture process of the camera sensor 12. Camera processor may generate the image capture profile 216 based at least in part on the sequence of contrast statistics 614 and the sequence of auto focus commands 616.

In some examples, camera processor 14 may determine a sequence of brightness statistics 714 associated with the image capture process of the camera sensor 12. Camera processor 14 may determine a sequence of auto exposure commands 716 associated with the image capture process of the camera sensor 12. Camera processor 14 may generate the image capture profile 216 based at least in part on the sequence of brightness statistics 714 and the sequence of auto exposure commands 716.

In some examples, camera processor 14 may extract a set of features 810 from the image 210 captured by the camera sensor 12. Camera processor 14 may extract an additional set of features 812 from an additional image 804 captured by an additional camera sensor 822, wherein the image 210 and the additional image 804 are images of the same scene captured by the camera sensor 12 and the additional camera sensor 822. Camera processor 14 may comparing the set of features 810 and the additional set of features 812 to determine one or more matching features 816 between the first set of features 810 and the second set of features 812. Camera processor 14 may generate the image capture profile 216 based at least in part on the one or more matching features 816.

In some examples, camera processor 14 may determine one or more data bundles 902 associated with the camera sensor 12 capturing the image 210, each of the one or more data bundles 902 including at least two or more of: camera sensor metrics 404 associated with a current operating point 402 of the camera sensor 12 associated with the camera sensor 12 capturing the image 210, camera sensor metadata associated with the camera sensor 12, a sequence of auto focus commands associated with the camera sensor capturing the image, a sequence of auto exposure commands 710 associated with the camera sensor 12 capturing the image 210, or an additional set of features from an additional image captured by an additional camera sensor. Camera processor 14 may generate the image capture profile 216 using a deep neural network based at least in part on the one or more data bundles 902.

Camera processor 14 may determine whether the image capture profile 216 is indicative of the image 210 being an authentic image (1104). Camera processor 14 may determine whether the image capture profile 216 is indicative of the image 210 being an authentic image using one of: a machine learning classification model or an unsupervised anomaly detection algorithm.

Processors 200 may, in response to determining that the image capture profile 216 is indicative of the image 210 being an authentic image, generate a digital signature 208 associated with the image 210 (1106). In some examples, camera processor 14 may determine whether all portions of a camera pipeline are trusted, and processor 14 may generate digital signature 208 associated with the image 210 further in response to determining that all portions of the camera pipeline are trusted. In some examples, camera processor 14 may generate the digital signature 208 that is associated with the image 210 and with image metadata associated with the image 210.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. An apparatus configured for camera processing, the apparatus comprising:
a memory; and
processing circuitry in communication with the memory and configured to:
receive a first image;
generate an image capture profile associated with the first image based at least in part on data generated during an image capture process, wherein the data is based on a sequence of one or more images received prior to the first image;
determine whether the first image is an authentic image based at least in part on the image capture profile; and
in response to determining that the first image is an authentic image, generate a digital signature associated with the first image.

2. The apparatus of claim 1, wherein to generate the image capture profile, the processing circuitry is further configured to:
determine camera sensor metrics associated with a current operating point of a camera sensor;
determine, out of a plurality of camera sensor profiles associated with a plurality of different operating points, a camera sensor profile associated with an operating point that corresponds to the current operating point of the camera sensor; and
generate the image capture profile based at least in part on comparing the camera sensor metrics with the camera sensor profile.

3. The apparatus of claim 1, wherein to generate the image capture profile, the processing circuitry is further configured to:
determine a disparity map of the first image based at least in part on phase information of the first image determined using one or more phase-detection auto focus (PDAF) sensors of a camera sensor;
extract a first set of features from the disparity map of the first image;
extract a second set of features from the first image captured by the camera sensor;
compare the first set of features and the second set of features to determine one or more matching features between the first set of features and the second set of features; and
generate the image capture profile based at least in part on the one or more matching features between the first set of features and the second set of features.

4. The apparatus of claim 1, wherein to generate the image capture profile, the processing circuitry is further configured to:
determine a sequence of contrast statistics associated with the image capture process;
determine a sequence of auto focus commands associated with the image capture process; and
generate the image capture profile based at least in part on the sequence of contrast statistics and the sequence of auto focus commands.

5. The apparatus of claim 1, wherein to generate the image capture profile, the processing circuitry is further configured to:
determine a sequence of brightness statistics associated with the image capture process;
determine a sequence of auto exposure commands associated with the image capture process; and
generate the image capture profile based at least in part on the sequence of brightness statistics and the sequence of auto exposure commands.

6. The apparatus of claim 1, wherein to generate the image capture profile, the processing circuitry is further configured to:
extract a set of features from the first image;
extract an additional set of features from an additional image captured by an additional camera sensor;
compare the set of features and the additional set of features to determine one or more matching features between the set of features and the additional set of features; and
generate the image capture profile based at least in part on the one or more matching features.

7. The apparatus of claim 1, wherein to generate the image capture profile, the processing circuitry is further configured to:
determine one or more data bundles associated with capturing the first image, each of the one or more data bundles including at least two or more of:
camera sensor metrics associated with an operating point of a camera sensor associated with capturing the first image,
camera sensor metadata associated with the camera sensor,
a sequence of auto focus commands associated with capturing the first image,
a sequence of auto exposure commands associated with capturing the first image, or
an additional set of features from an additional image captured by an additional camera sensor; and
generate the image capture profile using a deep neural network based at least in part on the one or more data bundles.

8. The apparatus of claim 1, wherein to determine whether the first image is an authentic image based at least in part on the image capture profile, the processing circuitry is further configured to:
determine whether the first image is an authentic image using one of: a machine learning classification model or an unsupervised anomaly detection algorithm

9. The apparatus of claim 1, wherein to generate the digital signature associated with the first image, the processing circuitry is further configured to:
determine whether all portions of a camera pipeline are trusted; and
generate the digital signature associated with the first image in response to determining that all portions of the camera pipeline are trusted.

10. The apparatus of claim 1, wherein to generate the digital signature associated with the first image, the processing circuitry is further configured to:
generate the digital signature that is associated with the first image and with image metadata associated with the first image.

11. A method comprising:
receiving a first image;
generating an image capture profile associated with the first image based at least in part on data generated during an image capture process, wherein the data is based on a sequence of one or more images received prior to the first image;
determining whether the first image is an authentic image based at least in part on the image capture profile; and
in response to determining that the first image is an authentic image, generating a digital signature associated with the first image.

12. The method of claim 11, wherein generating the image capture profile comprises:
determining camera sensor metrics associated with a current operating point of a camera sensor;
determining, out of a plurality of camera sensor profiles associated with a plurality of different operating points, a camera sensor profile associated with an operating point that corresponds to the current operating point of the camera sensor; and
generating the image capture profile based at least in part on comparing the camera sensor metrics with the camera sensor profile.

13. The method of claim 11, wherein generating the image capture profile comprises:
determining a disparity map of the first image based at least in part on phase information of the first image determined using one or more phase-detection auto focus (PDAF) sensors of a camera sensor;
extracting a first set of features from the disparity map of the first image;
extracting a second set of features from the first image captured by the camera sensor;
comparing the first set of features and the second set of features to determine one or more matching features between the first set of features and the second set of features; and
generating the image capture profile based at least in part on the one or more matching features between the first set of features and the second set of features.

14. The method of claim 11, wherein generating the image capture profile comprises:
determining a sequence of contrast statistics associated with the image capture process;
determining a sequence of auto focus commands associated the image capture process; and
generating the image capture profile based at least in part on the sequence of contrast statistics and the sequence of auto focus commands.

15. The method of claim 11, wherein generating the image capture profile comprises:
determining a sequence of brightness statistics associated with the image capture process;
determining a sequence of auto exposure commands associated the image capture process; and
generating the image capture profile based at least in part on the sequence of brightness statistics and the sequence of auto exposure commands.

16. The method of claim 11, wherein generating the image capture profile comprises:
extracting a set of features from the first image;
extracting an additional set of features from an additional image captured by an additional camera sensor;
comparing the set of features and the additional set of features to determine one or more matching features between the set of features and the additional set of features; and
generating the image capture profile based at least in part on the one or more matching features.

17. The method of claim 11, wherein generating the image capture profile comprises:
determining one or more data bundles associated with capturing the first image, each of the one or more data bundles including at least two or more of:
camera sensor metrics associated with an operating point of a camera sensor associated with capturing the first image,
camera sensor metadata associated with the camera sensor,
a sequence of auto focus commands associated with capturing the first image,
a sequence of auto exposure commands associated with capturing the first image, or
an additional set of features from an additional image captured by an additional camera sensor; and
generating the image capture profile using a deep neural network based at least in part on the one or more data bundles.

18. The method of claim 11, wherein determining whether the first image is an authentic image based at least in part on the image capture profile comprises:
determining whether the first image is an authentic image using one of: a machine learning classification model or an unsupervised anomaly detection algorithm.

19. The method of claim 11, further comprising:
determining whether all portions of a camera pipeline are trusted,
wherein generating the digital signature associated with the first image is further in response to determining that all portions of the camera pipeline are trusted.

20. The method of claim 11, wherein generating the digital signature associated with the first image further comprises generating the digital signature that is associated with the first image and with image metadata associated with the first image.

21. A non-transitory computer-readable storage medium storing instructions that, when executed, cause one or more processors to:
receive a first image;
generate an image capture profile associated with the first image based at least in part on data generated during an image capture process, wherein the data is based on a sequence of one or more images received prior to the first image;
determine whether the first image is an authentic image based at least in part on the image capture profile; and
in response to determining that the first image is an authentic image, generate a digital signature associated with the first image.

22. The non-transitory computer-readable storage medium of claim 21, wherein the instructions that, when executed, cause the one or more processors to generate the image capture profile further cause the one or more processors to:
determine camera sensor metrics associated with a current operating point of a camera sensor;
determine, out of a plurality of camera sensor profiles associated with a plurality of different operating points, a camera sensor profile associated with an operating point that corresponds to the current operating point of the camera sensor; and
generate the image capture profile based at least in part on comparing the camera sensor metrics with the camera sensor profile.

23. The non-transitory computer-readable storage medium of claim 21, wherein the instructions that, when executed, cause the one or more processors to generate the image capture profile further cause the one or more processors to:
determine a disparity map of the first image based at least in part on phase information of the first image determined using one or more phase-detection auto focus (PDAF) sensors of a camera sensor;
extract a first set of features from the disparity map of the first image;
extract a second set of features from the first image captured by the camera sensor;
compare the first set of features and the second set of features to determine one or more matching features between the first set of features and the second set of features; and
generate the image capture profile based at least in part on the one or more matching features between the first set of features and the second set of features.

24. The non-transitory computer-readable storage medium of claim 21, wherein the instructions that, when executed, cause the one or more processors to generate the image capture profile further cause the one or more processors to:
determine a sequence of contrast statistics associated with the image capture process;
determine a sequence of auto focus commands associated with the image capture process; and
generate the image capture profile based at least in part on the sequence of contrast statistics and the sequence of auto focus commands.

25. The non-transitory computer-readable storage medium of claim 21, wherein the instructions that, when executed, cause the one or more processors to generate the image capture profile further cause the one or more processors to:
determine a sequence of brightness statistics associated with the image capture process;
determine a sequence of auto exposure commands associated with the image capture process; and
generate the image capture profile based at least in part on the sequence of brightness statistics and the sequence of auto exposure commands.

26. The non-transitory computer-readable storage medium of claim 21, wherein the instructions that, when executed, cause the one or more processors to generate the image capture profile further cause the one or more processors to:
extract a set of features from the first image;
extract an additional set of features from an additional image captured by an additional camera sensor;
compare the set of features and the additional set of features to determine one or more matching features between the set of features and the additional set of features; and
generate the image capture profile based at least in part on the one or more matching features.

27. The non-transitory computer-readable storage medium of claim 21, wherein the instructions that, when executed, cause the one or more processors to generate the image capture profile further cause the one or more processors to:
determine one or more data bundles associated with capturing the first image, each of the one or more data bundles including at least two or more of:
camera sensor metrics associated with an operating point of a camera sensor associated with capturing the first image,
camera sensor metadata associated with the camera sensor,
a sequence of auto focus commands associated with capturing the first image,
a sequence of auto exposure commands associated with capturing the first image, or
an additional set of features from an additional image captured by an additional camera sensor; and
generate the image capture profile using a deep neural network based at least in part on the one or more data bundles.

28. The non-transitory computer-readable storage medium of claim 21, wherein the instructions that, when executed, cause the one or more processors to determine whether the image is an authentic image based at least in part on the image capture profile further cause the one or more processors to:
determine whether the first image is an authentic image using one of: a machine learning classification model or an unsupervised anomaly detection algorithm.

29. The non-transitory computer-readable storage medium of claim 21, wherein the instructions that, when executed, cause the one or more processors to generate the digital signature associated with the image further cause the one or more processors to:
determine whether all portions of a camera pipeline are trusted; and
generate the digital signature associated with the first image in response to determining that all portions of the camera pipeline are trusted.

30. The non-transitory computer-readable storage medium of claim 21, wherein the instructions that, when executed, cause the one or more processors to generate the digital signature associated with the first image further cause the one or more processors to:
generate the digital signature that is associated with the first image and with image metadata associated with the first image.

31. The apparatus of claim 1, wherein the processing circuitry is further configured to store the first image, digital signature, and image metadata associated with the first image in response to determining that the first image is an authentic image.

32. The apparatus of claim 2, wherein the camera sensor metrics include one or more of a frame time, a horizontal blanking interval time, a line time, and a vertical blanking interval time.

33. The method of claim 11, further comprising:
storing the first image, digital signature, and image metadata associated with the first image in response to determining that the first image is an authentic image.

34. The method of claim 12, wherein the camera sensor metrics include one or more of a frame time, a horizontal blanking interval time, a line time, and a vertical blanking interval time.
